(19) United States
(12) Patent Application Publication
(10) Pub. No.: US 2011/0118012 A1
(43) Pub. Date: May 19, 2011

(54) TIMING CONTROL DEVICE, INFORMATION PROCESSING DEVICE, AND OPERATION INSTRUCTION DEVICE

(76) Inventor: Hiromu UESHIMA, Shiga (JP)

(21) Appl. No.: 12/532,257

(22) PCT Filed: Mar. 27, 2008
(86) PCT No.: PCT/JP2008/000782

§ 371 Date: Jun. 30, 2010

(30) Foreign Application Priority Data
Mar. 27, 2007 (JP) 2007-080971

(51) Int. Cl. A63F 13/10; A63F 13/00

(52) U.S. Cl. 463/30; 463/43

(57) ABSTRACT

A cycle B and a phase P of a stepping motion of a player are detected by a mat 2. It is assumed that a time X from time when an event EVn is set until time when the next event EVn+1 is set is B. A time Z from base time 0 of the clock t_{F} until time when the event EVn is set is B−(R−P). The term R represents a remainder obtained by dividing a time T_{A} by the cycle B. The time T_{A} is a time until a moving object obj, which is generated in accordance with the setting of the event EVn, reaches a mat image 58. In this way, the moving object obj is controlled in accordance with the stepping motion of the player.

### TECHNICAL FIELD

The present invention relates to a timing controller and the related arts for analyzing input operation of a player and controlling timing for setting an event based on a result of the analysis.

Also, the present invention relates to an information processing apparatus and the related arts for analyzing input operation of a player and performing control based on a result of the analysis.

Further, the present invention relates to an action instructing apparatus and the related arts for instructing an action to be performed by a player which operates an input device placed on a floor

### BACKGROUND ART

An entertainment system is disclosed in Patent document 1 by the present applicant. The entertainment system plays back music on the basis of music data which is preliminarily stored, and objects displayed on a screen descend in synchronization with the music. When a player steps on a mat in accordance with the objects which descend, the player can perform stepping in synchronization with the music.

Patent Document 1: International Publication Application No. 2005/107884

### DISCLOSURE OF THE INVENTION

### Problem to be Solved by the Invention

However, in the above entertainment system, the music which is played back is preliminarily set, and therefore a user can not play using any favorite music.

It is therefore an object of the present invention to provide a timing controller and the related arts capable of performing input operation in a rhythm and beat which a player feels while the player listens to any music by matching control to the input operation.

It is another object of the present invention to provide an information processing apparatus and the related arts capable of simplifying design of a system by switching processing in accordance with a stationary state and an unstationary state of input operation by a player.

It is a further object of the present invention to provide an action instructing apparatus and the related arts capable of allowing a player to perform various actions as much as possible while an input device placed on a floor is employed.

### Solution of the Problem

In accordance with a first aspect of the present invention, a timing controller, comprising: an input unit operable to detect input operation by a player; a predicting unit operable to analyze cyclic repetition of the serial input operation by the player detected by the input unit, and predict occurrence timing of a future input operation; a setting unit operable to set an event for the future input operation on the basis of the predicted occurrence timing; and a controlling unit operable to perform a predetermined control in response to the set event to effect a predetermined result at the predicted occurrence timing of the future input operation.

In accordance with this configuration, the occurrence timing of the future input operation is predicted by analyzing the input operation, then the event for the future input operation whose occurrence timing is predicted is set, and thereby it is possible to perform the real-time processing. Therefore, it is possible to be small the scale of the storage means such as a memory, and reduce the cost because a device for playing back the input signal as stored is not required, in comparison with the case where the input signal is played back and the event is set after storing temporarily and analyzing the input signal. Incidentally, in the case where the input signal is temporarily stored and analyzed, subsequently, the input signal is played back, and the event is set, a delay occurs because of the storing, analyzing, and playing back, and therefore it is not the real-time processing.

Also, since the occurrence timing of the future input operation is predicted, while performing the real-time processing, it is possible to effect the predetermined result at the occurrence timing of the future input operation. As the result, for example, it is possible to exhibit the following advantage.

It is assumed that the player performs the input operation in synchronization with music while listening to the any music. In this case, in accordance with the present invention, the event is set on the basis of not the music but the input operation of the player, and thereby the predetermined control is performed. Accordingly, the player can effect the predetermined result only by performing the input operation in his/her rhythm. In other words, since the timing when the predetermined result is effected is matched to the timing of the input operation of the player, the player can perform the input operation in a rhythm and beat which the player feels while listening to any music.

Further, in the case where the predetermined result is effected in a constant rhythm, the case represents that the player performs the input operation in the constant rhythm, and therefore the player can recognize that he/she performs the input operation in the constant rhythm by sensing such predetermined result.

Incidentally, the predetermined result means that an object to be controlled becomes a predetermined state. The term “predetermined state” contains a predetermined appearance, a predetermined position, predetermined sound, and so on. The term “appearance” is used as a term including shape, pattern, and color.

In this timing controller, wherein the predetermined control is control of a predetermined image, and wherein the controlling unit controls the predetermined image in response to the set event to allow the predetermined image to effect the predetermined result at the occurrence timing as predicted.

In accordance with this configuration, since the occurrence timing of the future input operation is predicted, while performing the real-time processing, it is possible to make the predetermined image to effect the predetermined result at the occurrence timing of the future input operation. As the result, for example, it is possible to exhibit the following advantage.

It is assumed that the player performs the input operation in synchronization with music while listening to the any music. In this case, in accordance with the present invention, the event is set on the basis of not the music but the input operation of the player, and thereby the predetermined image is controlled. Accordingly, the player allows the predetermined image to effect the predetermined result only by performing the input operation in his/her rhythm. In other words, since the timing when the predetermined image effects the predetermined result is matched to the timing of the input operation of the player, the player can perform the input operation in a rhythm and beat which the player feels while listening to any music.

Further, in the case where the predetermined image effects the predetermined result in a constant rhythm, the case represents that the player performs the input operation in the constant rhythm, and therefore the player can recognize that he/she performs the input operation in the constant rhythm by watching such predetermined result.

In this timing controller, wherein the controlling unit controls change of the predetermined image in response to the set event to effect the predetermined result at the occurrence timing as predicted, and wherein the change of the predetermined image includes change of a position and/or an appearance. Incidentally, the term “appearance” is used as a term including shape, pattern, and color.

In this timing controller, wherein the setting unit determines at least one of change-start timing and appearance timing on a screen of the predetermined image on the basis of the occurrence timing as predicted, and sets the event on the basis of a result of the determination. Incidentally, the term “change” is used as a term including change of a position and change of an appearance. The term “appearance” is used as a term including shape, pattern, and color.

In the above timing controller, wherein the predetermined control is control of predetermined sound, and wherein the controlling unit controls the predetermined sound in response to the set event to allow the predetermined sound to effect the predetermined result at the occurrence timing as predicted.

In accordance with this configuration, since the occurrence timing of the future input operation is predicted, while performing the real-time processing, it is possible to make the predetermined sound to effect the predetermined result at the occurrence timing of the future input operation. As the result, for example, it is possible to exhibit the following advantage.

It is assumed that the player performs the input operation in synchronization with music while listening to the any music. In this case, in accordance with the present invention, the event is set on the basis of not the music but the input operation of the player, and thereby the predetermined sound is controlled. Accordingly, the player allows the predetermined sound to effect the predetermined result only by performing the input operation in his/her rhythm. In other words, since the timing when the predetermined sound effects the predetermined result is matched to the timing of the input operation of the player, the player can perform the input operation in a rhythm and beat which the player feels while listening to any music.

Further, in the case where the predetermined sound effects the predetermined result in a constant rhythm, the case represents that the player performs the input operation in the constant rhythm, and therefore the player can recognize that he/she performs the input operation in the constant rhythm by hearing such predetermined result.

In this timing controller, wherein the setting unit determines at least one of output-start timing and change-start timing of the predetermined sound on the basis of the occurrence timing as predicted, and sets the event on the basis of a result of the determination.

In the above timing controller, wherein the predetermined control is control of an external device and/or an external computer program, and wherein the controlling unit controls the external device and/or the external computer program in response to the set event to effect the predetermined result at the occurrence timing as predicted.

In accordance with this configuration, since the occurrence timing of the future input operation is predicted, while performing the real-time processing, it is possible to make the external device or the external computer program to effect the predetermined result at the occurrence timing of the future input operation. As the result, for example, it is possible to exhibit the following advantage.

It is assumed that the player performs the input operation in synchronization with music while listening to the any music. In this case, in accordance with the present invention, the event is set on the basis of not the music but the input operation of the player, and thereby the external device or the external computer program is controlled. Accordingly, the player allows the external device or the external computer program to effect the predetermined result only by performing the input operation in his/her rhythm. In other words, since the timing when the external device or the external computer program effects the predetermined result is matched to the timing of the input operation of the player, the player can perform the input operation in a rhythm and beat which the player feels while listening to any music.

Further, in the case where the predetermined result is effected in a constant rhythm, the case represents that the player performs the input operation in the constant rhythm, and therefore the player can recognize that he/she performs the input operation in the constant rhythm by sensing such predetermined result.

In the above timing controller, wherein the predetermined control is control of a predetermined thing or a predetermined material, and wherein the controlling unit controls the predetermined thing or the predetermined material in response to the set event to effect the predetermined result at the occurrence timing as predicted.

In accordance with this configuration, since the occurrence timing of the future input operation is predicted, while performing the real-time processing, it is possible to make the predetermined thing or the predetermined material to effect the predetermined result at the occurrence timing of the future input operation. As the result, for example, it is possible to exhibit the following advantage.

It is assumed that the player performs the input operation in synchronization with music while listening to the any music. In this case, in accordance with the present invention, the event is set on the basis of not the music but the input operation of the player, and thereby the predetermined thing or the predetermined material is controlled. Accordingly, the player allows the predetermined thing or the predetermined material to effect the predetermined result only by performing the input operation in his/her rhythm. In other words, since the timing when the predetermined thing or the predetermined material effects the predetermined result is matched to the timing of the input operation of the player, the player can perform the input operation in a rhythm and beat which the player feels while listening to any music.

Further, in the case where the predetermined thing or the predetermined material effects the predetermined result in a constant rhythm, the case represents that the player performs the input operation in the constant rhythm, and therefore the player can recognize that he/she performs the input operation in the constant rhythm by sensing such predetermined result.

In this timing controller, wherein the controlling unit controls change of the predetermined thing or the predetermined material in response to the set event to effect the predetermined result at the occurrence timing as predicted, and wherein the change of the predetermined thing or the predetermined material includes change of a position and/or an appearance. Incidentally, the term “appearance” is used as a term including shape, pattern, and color.

In this timing controller, wherein the setting unit determines at least one of change-start timing and appearance timing of the predetermined thing or the predetermined material on the basis of the occurrence timing as predicted, and sets the event on the basis of a result of the determination. Incidentally, the term “change” is used as a term including change of a position and change of an appearance. The term “appearance” is used as a term including shape, pattern, and color.

In the above timing controller, wherein the setting unit sets the event a predetermined time prior to the occurrence timing as predicted, and wherein the controlling unit starts the predetermined control in response to the set event to effect the predetermined result after elapse of the predetermined time.

In accordance with this configuration, a time (referred to as “activation time”) from time when the control is started until time when the predetermined result is effected is certainly a certain time, i.e., a constant time without depending on the input operation of the player. As the result, even the speed of the cyclic repetition of the input operation differs, it is possible to perform the common control during the activation time and at the time when the activation time has elapsed, and therefore the constant expression and effect can be supplied without depending on the speed of the cyclic repetition of the input operation.

In this timing controller, wherein the predetermined control is control of a predetermined image, wherein the controlling unit starts change of the predetermined image in response to the set event to allow the predetermined image to effect the predetermined result after elapse of the predetermined time, and wherein a process of the change of the predetermined image does not depend on the input operation.

In accordance with this configuration, since the process of the change of the predetermined image during the activation time and the predetermined result do not depend on the input operation, even the cyclic repetition of the input operation differs, the constant expression and effect can be supplied by the predetermined image.

Incidentally, the term “change” is used as a term including change of a position and change of an appearance. The term “appearance” is used as a term including shape, pattern, and color.

In this timing controller, wherein the controlling unit sets speed of the change of the predetermined image to a constant value without depending on the input operation.

In the above timing controller, wherein the predicting unit predicts the occurrence timing of the future input operation on the basis of a frequency and a phase of the cyclic repetition of the input operation.

In this timing controller, wherein the predicting unit comprising: a cycle detecting unit operable to detect a cycle of the cyclic repetition of the input operation; a phase detecting unit operable to the phase of the cyclic repetition of the input operation; and a unit operable to predict the occurrence timing of the future input operation on the basis of the cycle and the phase of the cyclic repetition of the input operation.

In this timing controller, wherein the predicting unit corrects a result of the prediction of the occurrence timing of the future input operation in accordance with a shift of the phase of the input operation.

In accordance with this configuration, even if the phase changes in midstream of the serial input operation, since the prediction result is corrected in accordance with the change, it is possible to prevent the shift of the phase from affecting the prediction result.

In the above timing controller, wherein the controlling unit generates a predetermined effect when timing of the input operation by the player detected by the input unit substantially coincides with timing when the predetermined result is effected by the predetermined control.

In the above timing controller, wherein the controlling unit performs the predetermined control in accordance with the event set by the event setting unit when the input operation of the player is stationary.

In accordance with this configuration, the event is set in accordance with the predetermined algorithm which does not depend on the input of the player before the input operation of the player is stationary, and the control according to the event can be performed.

In the above timing controller, wherein the input unit comprising: a detecting unit that is placed on a floor, and detects a stepping motion as the input operation of the player.

In accordance with this configuration, since the occurrence timing of the stepping motion as the input operation is predicted, while performing the real-time processing, it is possible to effect the predetermined result at the occurrence timing of the future stepping motion. As the result, for example, it is possible to exhibit the following advantage.

It is assumed that the player performs the stepping motion in synchronization with music while listening to the any music. In this case, in accordance with the present invention, the predetermined control is performed on the basis of not the music but the stepping motion of the player. Accordingly, the player can effect the predetermined result only by performing the stepping in his/her rhythm. In other words, since the timing when the predetermined result is effected is matched to the timing of the stepping motion of the player, the player can perform the stepping motion in a rhythm and beat which the player feels while listening to any music.

Further, in the case where the predetermined result is effected in a constant rhythm, the case represents that the player performs the stepping motion in the constant rhythm, and therefore the player can recognize that he/she performs the stepping motion in the constant rhythm by sensing such predetermined result.

In the above timing controller, wherein the input unit comprising: a detecting unit operable to detect a strike as the input operation of the player.

In accordance with this configuration, since the occurrence timing of the strike as the input operation is predicted, while performing the real-time processing, it is possible to effect the predetermined result at the occurrence timing of the future strike. As the result, for example, it is possible to exhibit the following advantage.

It is assumed that the player performs the strike in synchronization with music while listening to the any music. In this case, in accordance with the present invention, the predetermined control is performed on the basis of not the music but the strike of the player. Accordingly, the player can effect the predetermined result only by performing the strike in his/her rhythm. In other words, since the timing when the predetermined result is effected is matched to the timing of the strike of the player, the player can perform the strike in a rhythm and beat which the player feels while listening to any music.

Further, in the case where the predetermined result is effected in a constant rhythm, the case represents that the player performs the strike in the constant rhythm, and therefore the player can recognize that he/she performs the strikes in the constant rhythm by sensing such predetermined result.

The above timing controller further comprising: a triggering unit operable to generate a trigger when the input operation by the player detected by the input unit satisfies a predetermined condition, wherein the predicting unit predicts the occurrence timing of the future input operation by analyzing cyclic repetition of the trigger.

In this timing controller, wherein the triggering unit generates the trigger when movement of the input unit which is moved by the player in a three-dimensional space satisfies the predetermined condition.

It is assumed that the player moves the input unit in a three-dimensional space in synchronization with music while listening to the any music. In this case, in accordance with the present invention, the predetermined control is performed on the basis of not the music but the movement of the input unit by the player. Accordingly, the player can effect the predetermined result only by moving the input unit in his/her rhythm. In other words, since the timing when the predetermined result is effected is matched to the timing when the player moves the input unit, the player can move the input unit in a rhythm and beat which the player feels while listening to any music.

Further, in the case where the predetermined result is effected in a constant rhythm, the case represents that the player moves the input unit in the constant rhythm, and therefore the player can recognize that he/she performs the motions in the constant rhythm by sensing such predetermined result.

In this timing controller, wherein the predetermined condition is that acceleration of the input unit exceeds a predetermined value.

In the above timing controller, wherein the input unit detects motion of the player as the input operation on the basis of an image obtained by imaging, wherein the triggering unit generates the trigger when the motion of the player as detected satisfies the predetermined condition.

In this timing controller, wherein the input unit detects the motion of the player in a three-dimensional space on the basis of the image obtained by imaging the motion of the player.

It is assumed that the player moves the body in a three-dimensional space in synchronization with music while listening to the any music. In this case, in accordance with the present invention, the predetermined control is performed on the basis of not the music but the motion of the player. Accordingly, the player can effect the predetermined result only by moving the body in his/her rhythm. In other words, since the timing when the predetermined result is effected is matched to the timing when the player moves the body, the player can move the body in a rhythm and beat which the player feels while listening to any music.

Further, in the case where the predetermined result is effected in a constant rhythm, the case represents that the player moves the body in the constant rhythm, and therefore the player can recognize that he/she moves the body in the constant rhythm by sensing such predetermined result.

In this timing controller, wherein the input unit detects the motion of the player in the three-dimensional space on the basis of the image obtained by imaging when a retroreflective member which is moved by the player is irradiated with predetermined light from a side of imaging.

Since the retroreflective member irradiated with the light is photographed, luminance of an image of the retroreflective member in the photographed image is higher than that of the background, and therefore it is easily possible to extract the image thereof.

In this timing controller, wherein the input unit detects the motion of the player in the three-dimensional space on the basis of a difference image between an image obtained by imaging when irradiating the predetermined light and an image obtained by imaging when the predetermined light is not emitted.

In accordance with this configuration, it is simply possible to eliminate light other than the light reflected by the retroreflective member.

In the above timing controller, wherein the input unit detects the motion of the player in a three-dimensional space on the basis of an image as obtained when a plurality of markers arranged along an edge of a screen of a display device is imaged by a imaging device which is moved by the player.

It is assumed that the player moves the imaging device in a three-dimensional space in synchronization with music while listening to the any music. In this case, in accordance with the present invention, the predetermined control is performed on the basis of not the music but the movement of the imaging device which is moved by the player. Accordingly, the player can effect the predetermined result only by moving the imaging device in his/her rhythm. In other words, since the timing when the predetermined result is effected is matched to the timing when the player moves the imaging device, the player can move the imaging device in a rhythm and beat which the player feels while listening to any music.

Further, in the case where the predetermined result is effected in a constant rhythm, the case represents that the player moves the imaging device in the constant rhythm, and therefore the player can recognize that he/she moves the imaging device in the constant rhythm by sensing such predetermined result.

In accordance with a second aspect of the present invention, a timing controlling method, comprising the steps of: detecting input operation by a player; analyzing cyclic repetition of the serial input operation by the player as detected to predict occurrence timing of a future input operation; setting an event for the future input operation on the basis of the predicted occurrence timing; and performing a predetermined control in response to the set event to effect a predetermined result at the predicted occurrence timing of the future input operation.

In accordance with this configuration, the same advantage as the above first aspect of the timing controller can be gotten.

In accordance with a third aspect of the present invention, a timing controlling program is a computer program for executing the above second aspect of the timing controlling method. The advantage thereof is the same as that of the first aspect of the timing controller.

In accordance with a fourth aspect of the present invention, a recording medium is a computer readable recording medium storing the above third aspect of the timing controlling program. The advantage thereof is the same as that of the first aspect of the timing controller.

In accordance with a fifth aspect of the present invention, an information processing apparatus, comprising: an input unit operable to detect input operation by a player; a stationary determining unit operable to analyze the serial input operation by the player detected by the input unit, and determine whether or not the input operation is stationary; a first processing unit operable to set an event in accordance with a predetermined algorithm which does not depend on the input operation when it is determined that the input operation is not stationary; and a second processing unit operable to set the event on the basis of a cycle of cyclic repetition of the serial input operation when it is determined that the input operation is stationary.

It is often difficult to execute a process based on motion of the player which is not stationary while it is often relatively easy to execute a process based on motion of the player which is stationary. Accordingly, before the input operation of the player is stationary, the event is set in accordance with the predetermined algorithm which does not depend on the input operation of the player, meanwhile, after the input operation of the player is stationary, the event is set in synchronization with the input operation of the player. In this way, it is possible to simplify design of the system by switching the processing in accordance with the stationary state and unstationary state of the input operation of the player.

In this information processing apparatus, wherein the stationary determining unit determines whether or not the input operation of the player is stationary on the basis of a deviation based on the input operation of the player detected by the input unit.

Incidentally, the term “deviation” represents a deviation from a numerical value which is standard. Also, the term “deviation” is a term including a standard deviation.

This information processing apparatus further comprising: a predicting unit operable to predict occurrence timing of a future input operation on the basis of the serial input operation by the player, wherein the deviation is a difference between timing of the input operation detected by the input unit and the predicted occurrence timing.

Also, in this information processing apparatus, wherein the deviation is a difference between an average value of a time interval between the input operation and the subsequent input operation, and a time interval between the current input operation and the previous input operation.

In the above information processing apparatus, wherein the stationary determining unit determines whether or not the input operation is stationary on the basis of the deviation by giving hysteresis.

While the input operation of a person is unstable, in accordance with this configuration, it is possible to avoid occurrence of needless inversion of the state (the change from the unstationary state to the stationary state, or the change from the stationary state to the unstationary state).

In the above information processing apparatus, wherein the stationary determining unit does not use the deviation for the determination when the deviation is larger than a predetermined value.

In accordance with this configuration, it is possible to determine the stationary state in consideration that a person performs the input operation. Even if the input operation is stationary, since it is performed by a person, it may suddenly become unstationary and shortly become stationary. In this case, by determining continuance of the stationary state, it is possible to provide with the process and effect smooth for the player Incidentally, in such case, if the unstationary state is determined and, immediately afterward, the stationary state is determined, it is difficult to provide with the process and effect smooth for the player.

In accordance with a sixth aspect of the present invention, an information processing method, comprising the steps of: detecting input operation by a player; analyzing the serial input operation by the player as detected to determine whether or not the input operation is stationary; setting an event in accordance with a predetermined algorithm which does not depend on the input operation when it is determined that the input operation is not stationary; and setting the event on the basis of a cycle of cyclic repetition of the serial input operation when it is determined that the input operation is stationary.

In accordance with this configuration, the same advantage as the above fifth aspect of the information processing apparatus can be gotten.

In accordance with a seventh aspect of the present invention, an information processing program is a computer program for executing the above sixth aspect of the information processing method. The advantage thereof is the same as that of the fifth aspect of the information processing apparatus.

In accordance with an eighth aspect of the present invention, a recording medium is a computer readable recording medium storing the above seventh aspect of the information processing program. The advantage thereof is the same as that of the fifth aspect of the information processing apparatus.

In accordance with a ninth aspect of the present invention, an action instructing apparatus an action instructing apparatus which is used by connecting to a display device, comprising: a input unit that is placed on a floor and includes a plurality of detecting unit each of which detects input by a player; and an image controlling unit operable to control an image displayed on the display device on the basis of a result of the detection by the input unit, wherein the image controlling unit applies change according to a first expression to the image when at least the three detecting units simultaneously detect the input, the change according to the first expression being different from that when the two or less detecting units detect the input, and wherein in a state in which at least the one detecting unit continuously detects the input after applying the change according to the first expression, in response to that the other two detecting units alternately detect the input, the image controlling unit applies change according to a second expression to the image.

In accordance with this configuration, in the case where at least the three detecting units simultaneously detect the input, the case represents that the hand as well as both the feet of the player are detected. Also, since the input unit is placed on the floor, at this time, the player crouches. At this time, the change according to the first expression is applied to the image. And, in a state in which at least the one detecting unit continuously detects the input, in the case where the other two detecting units alternately detect the input, the case represents that the player steps while keeping the crouching state. At this time, the change according to the second expression is applied to the image.

By such serial motions of the player, i.e., the serial operations of the input unit, it is possible to apply the change according to the first expression and the change according to the second expression to the image being displayed. In other words, it is possible to make the player perform such serial motions, i.e., the motions of crouching, keeping the state thereof, and stepping by making such contents, i.e., such an application program as the player has to give the change according to the first expression and the change according to the second expression to the image being displayed.

In this action instructing apparatus, wherein the image to be controlled by the image controlling unit is a player character which moves corresponding to the player, wherein the change according to the first expression is a motion that the player character crouches, and wherein the change according to the second expression is a motion that the player character walks or runs while keeping a crouching state.

In accordance with this configuration, since the movement of the player character is nearly matched to the motion of the player, it is further possible to give a feeling of oneness.

In accordance with a tenth aspect of the present invention, an action instructing apparatus which is used by connecting to a display device, comprising: a input unit that is placed on a floor and includes a plurality of detecting unit each of which detects input by a player; and an image controlling unit operable to control an image displayed on the display device on the basis of a result of the detection by the input unit, wherein the image controlling unit applies change according to a first expression to the image in response to that the two detecting units alternately detect the input, and wherein in a state in which the change according to the first expression is applied to the image, when at least the other one detecting unit detects the input, the image controlling unit applies change according to a second expression to the image.

In accordance with this configuration, in the case where the two detecting units alternately detect the input, the case represents that the player performs the stepping motion. At this time, the change according to the first expression is applied to the image. And, in the state thereof, in the case where at least the other one detecting unit detects the input, the case represents that the player crouches.

By such the serial motions of the player, i.e., the serial operations of the input unit, it is possible to apply the change according to the first expression and the change according to the second expression to the image being displayed. In other words, it is possible to make the player perform such serial motions, i.e., the motion of crouching while performing the stepping motion by making such contents, i.e., such an application program as the player has to give the change according to the first expression and the change according to the second expression to the image being displayed.

In this action instructing apparatus, wherein the image to be controlled by the image controlling unit is a player character which moves corresponding to the player, wherein the change according to the first expression is a motion that the player character walks or runs, and wherein the change according to the second expression is a motion that the player character makes sliding.

In accordance with this configuration, since the movement of the player character and the motion of the player can be made similar to each other, it is further possible to give a feeling of oneness.

Incidentally, in the above ninth aspect of the action instructing apparatus and the above tenth aspect of the action instructing apparatus, the change according to the first expression and the change according to the second expression include the case where the visual effect is given to the player by changing the background and so on in a first-person standpoint in which the player character is not displayed as well as the case where the player character changes in a third-person standpoint in which the player character moving corresponding to the player is displayed

Besides, the above recording mediums include, for example, a flexible disk, a hard disk, a magnetic tape, a magneto-optical disk, a CD (including CD-ROM, Video-CD), a DVD (including DVD-Video, DVD-ROM, DVD-RAM), a ROM cartridge, a RAM memory cartridge with a battery backup unit, a flash memory cartridge, a nonvolatile RAM cartridge, and so on.

### BRIEF DESCRIPTION OF DRAWING

The novel features of the present invention are set forth in the appended any one of claims. The invention itself, however, as well as other features and advantages thereof, will be best understood by reference to the detailed description of specific embodiments which follows, when read in conjunction with the accompanying drawings, wherein:

FIG. 1 is a view showing the overall configuration of an entertainment system in accordance with a first embodiment of the present invention.

FIG. 2 is a schematic diagram for showing the electric configurations of a mat unit 7, an adapter 1, and a cartridge 3 of FIG. 1.

FIG. 3 is a view showing an example of a play screen.

FIG. 4 is a view showing another example of a play screen.

FIG. 5 is an explanatory view of a method for determining set timing of an event EVn.

FIG. 6 is an explanatory view of a method for determining set timing of a next event EVn+1 when the event EVn is set earlier.

FIG. 7 is an explanatory view of a method for determining set timing of a next event EVn+1 when the event EVn is set more retarded.

FIG. 8 is a flow chart showing an overall process flow of a processor 20 of FIG. 2.

FIG. 9 is a flow chart showing a process for acquiring a cycle B of stepping of a player in step S3 of FIG. 8.

FIG. 10 is a flow chart showing a process for counting time t_{F} in step S5 of FIG. 8.

FIG. 11 is a flow chart showing a process for detecting a phase P in step S7 of FIG. 8.

FIG. 12 is a flow chart showing a process for determining a stationary state in step S9 of FIG. 8.

FIG. 13 is a flow chart showing a process for calculating an event set time X in step S11 of FIG. 8.

FIG. 14 is a flow chart showing a process for setting the event EVn in step S13 of FIG. 8.

FIG. 15 is a flow chart showing a process for switching a pattern in step S19 of FIG. 8.

FIG. 16 is a view showing an example of a play screen in accordance with a second embodiment of the present invention.

FIG. 17 is a view showing an example of a play screen containing a player character 70 which stands on one leg in accordance with the second embodiment.

FIG. 18 is a view showing an example of a play screen containing the player character 70 which runs while keeping a crouching state in accordance with the second embodiment.

FIG. 19 is a view showing an example of a play screen containing the player character 70 which makes sliding in accordance with the second embodiment.

FIG. 20 is a view showing an example of a play screen containing an obstacle 66 which moves in a vertical direction in accordance with the second embodiment.

FIG. 21 is a view showing an example of a play screen containing a pit 68 in accordance with the second embodiment.

FIG. 22 is a view showing an example of a play screen containing a road surface 62 which moves in a direction opposite to an advancing direction of the player character 70 in accordance with the second embodiment.

FIG. 23 is a flow chart showing a process for controlling moving objects in step S17 of FIG. 8.

### EXPLANATION OF REFERENCES

1 . . . adapter, 3 . . . cartridge, 5 . . . television monitor, 7 . . . mat unit, 20 . . . processor, 22 . . . external memory, 24 . . . IR receiver, 30 . . . IR emitting section, 32 . . . MCU, ST1 to ST4 . . step area, and SW1 to SW4 . . . foot switch.

### BEST MODE FOR CARRYING OUT THE INVENTION

In what follows, several embodiments of the present invention will be explained in detail with reference to the accompanying drawings. Meanwhile, like references indicate the same or functionally similar elements throughout the respective drawings, and therefore redundant explanation is not repeated.

### First Embodiment

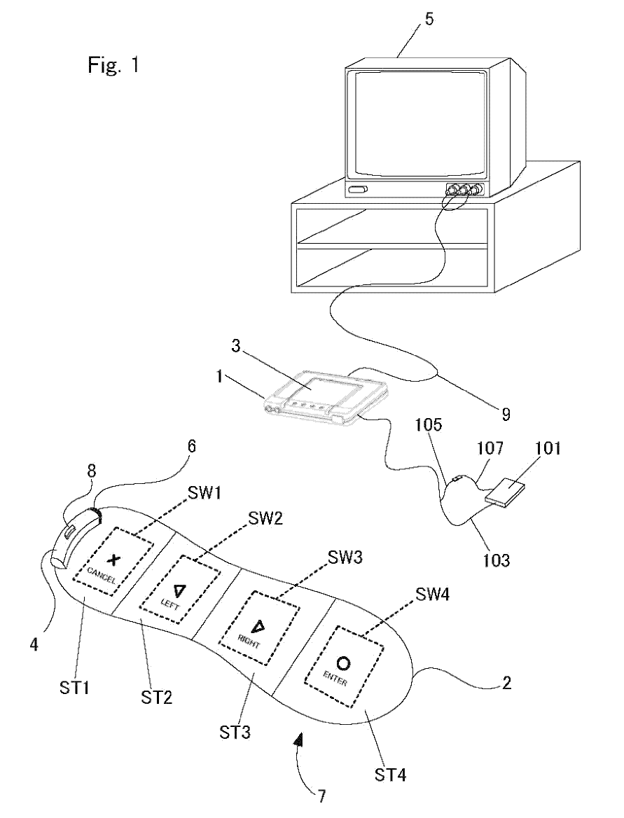

FIG. 1 is a view showing the overall configuration of an entertainment system in accordance with a first embodiment of the present invention. Referring to FIG. 1, this entertainment system is provided with an adapter 1, a cartridge 3, a mat unit 7 and a television monitor 5. The cartridge 3 is inserted into the adapter which is provided with a power supply circuit for supplying the cartridge 3 with power-supply voltage. Also, the adapter 1 is connected to the television monitor 5 through an AV cable 9. Accordingly, a video signal and audio signals generated by the cartridge 3 are given to the television monitor 5 through the adapter 1 and the AV cable 9. Herewith, the television monitor 5 displays various screens as described below, and a speaker (not shown in the figure) outputs music and sound effect.

Further, the cartridge 3 is connected to a digital audio player 101 through the adapter 1 and a cable 103. Analog audio signals output by the digital audio player 101 are mixed with the analog audio signals generated by the cartridge 3, and then are output to the AV cable 9.

Incidentally, the cable 103 includes a cable 105 which diverges from the cable 103. A USB terminal is attached to a head of the cable 105. Also, the cable 105 includes a power line and a ground line which are respectively connected to a power line and a ground line of the adapter 1. On the other hand, in general, a cable 107 for charging can be connected to the digital audio player 101. A USB terminal is attached to a head of the cable 107. The cable 105 can be connected to the cable 107 through the USB terminals. Accordingly, the adapter 1 can supply the digital audio player 101 with power-supply voltage through the cables 105 and 107. Needless to say, this connection is optional for a user.

The mat unit 7 comprises a mat 2 and a circuit box 4. The circuit box 4 is fixed to one end of the mat 2. The circuit box 4 is provided with a power supply switch 8 at its surface and an infrared filter 6 which transmits only infrared light at one end thereof. An infrared light (IR) emitting section 30 (to be hereinafter described) including an infrared light emitting diode (not shown in the figure) is arranged behind the infrared filter 6. On the other hand, four step areas ST1, ST2, ST3 and ST4 are formed in the surface of the mat 2. The mat 2 is also provided with foot switches SW1, SW2, SW3 and SW4 inside thereof corresponding respectively to the step areas ST1, ST2, ST3 and ST4. When the step area ST1, ST2, ST3 or ST4 is stepped on, the corresponding foot switch SW1, SW2, SW3 or SW4 is turned on. The foot switches SW1 to SW4 are, for example, membrane switches. Incidentally, the term “foot switch SW” is used to generally represent the foot switches SW1 to SW4. Also, the term “step area ST” is used to generally represent the step areas ST1 to ST4.

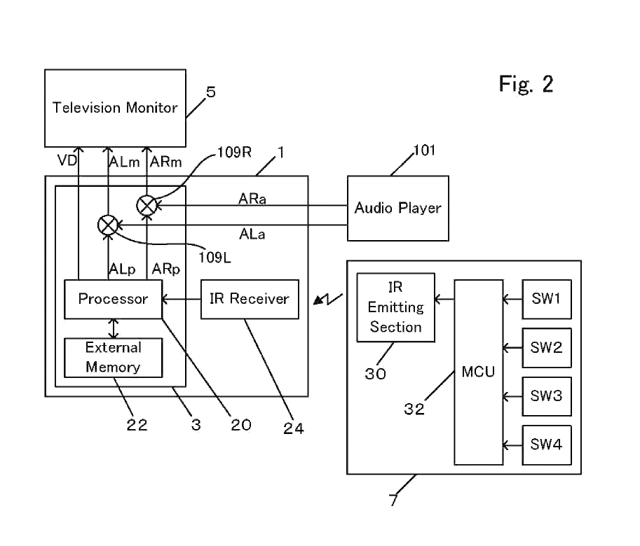

FIG. 2 is a schematic diagram for showing the electric configurations of the mat unit 7, the adapter 1, and the cartridge 3 of FIG. 1. Referring to FIG. 2, the mat unit 7 includes the infrared light (IR) emitting section 30, an MCU (Micro Controller Unit) 32, and the foot switches SW1 to SW4. The circuit box 4 is provided with the IR emitting section 30 and the MCU 32 inside thereof. The mat 2 is provided with the foot switches SW1 to SW4 inside thereof. The MCU 32 receives ON/OF information from the foot switches SW1 to SW4, and transmits the ON/OF information from the foot switches SW1 to SW4 to an IR receiver 24 of the adapter 1 via infrared communication by driving the IR emitting section 30.

On the other hand, the cartridge 3 to be inserted into the adapter 1 includes a processor 20, an external memory 22 (e.g., a flash memory, a ROM, and/or a RAM), and mixing circuits 109L and 109R while the adapter 1 includes the infrared light (IR) receiver 24. The infrared signal transmitted from the IR emitting section 30 of the mat unit 7, i.e., the ON/OFF information of the foot switches SW1 to SW4 is received by the IR receiver 24 of the adapter 1, and is given to the processor 20 of the cartridge 3.

The processor 20 of the cartridge 3 is coupled with the external memory 22. The external memory 22 includes a program area, an image data area, and an audio data area. The program area stores control programs for making the processor 20 execute processes as shown in flowcharts as described below. The image data area stores all of image data which constitutes screens to be displayed on the television monitor 5, and other necessary image data. The audio data area stores audio data for sound effect and so on. The master processor 20 executes the control programs in the program area, fetches the image data in the image data area and the audio data in the audio data area, performs necessary processes thereto, and generates a video signal VD and audio signals ALp and ARp. In this case, the processor 20 reflects the ON/OFF information of the foot switches SW1 to SW4 given by the IR receiver 24 on processing.

The video signal VD is supplied to the television monitor 5 through the AV cable 9 from the adapter 1. Also, the left channel analog audio signal ALp generated by the processor 20 and the left channel analog audio signal ALa input from the digital audio player 101 are mixed by the mixing circuit 109L, and is output as an audio signal ALm to the speaker of the television monitor 5 via the AV cable 9. In the same manner, the right channel analog audio signal ARp generated by the processor 20 and the right channel analog audio signal ARa input from the digital audio player 101 are mixed by the mixing circuit 109R, and is output as an audio signal ARm to the speaker of the television monitor 5 via the AV cable 9.

Although not shown in the figure, the processor 20 includes various functional blocks such as a CPU (central processing unit), a graphics processor, a sound processor, and a DMA controller, and in addition to this, includes an A/D converter for receiving analog signals, an input/output control circuit for receiving input digital signals such as key manipulation signals and infrared signals (the ON/OFF information of the foot switches SW1 to SW4 in the present embodiment) and giving the output digital signals to external devices, an internal memory, and so on.

The CPU executes the control programs stored in the external memory 22. The CPU receives the digital signals from the A/D converter and the digital signals from the input/output control circuit, and then executes necessary operations based on these signals in accordance with the control programs. The graphics processor performs graphics processing, which the result of the operation of the CPU requires, to the image data stored in the external memory 22 to generate the video signal VD representing images to be displayed on the television monitor 5. The sound processor performs sound processing, which the result of the operation of the CPU requires, to the audio data stored in the external memory 22 to generate the audio signals ALp and ARp representing sound effect and so on. The internal memory is, for example, a RAM, and is used as a working area, a counter area, a register area, a temporary data area, a flag area and/or the like area.

Next, play screens which are displayed on the television monitor 5 by the entertainment system in accordance with the first embodiment will be described.

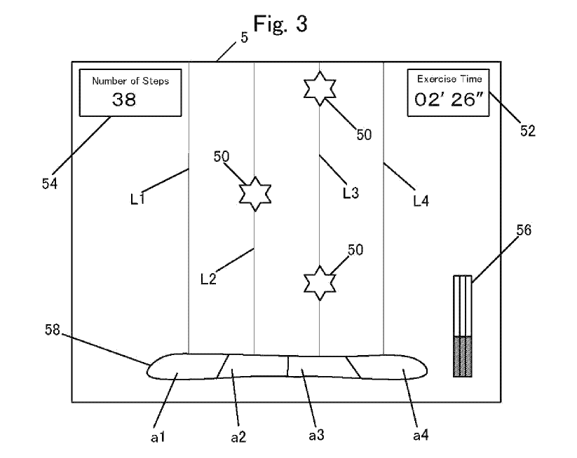

FIG. 3 is a view showing an example of the play screen. Referring to FIG. 3, the play screen displayed on the television monitor 5 by the processor 20 contains a step number displaying section 54 which displays the number of steps of a player, an exercise time displaying section 52 which displays an exercise time of the player, and a gauge 56 which indicates level fluctuations of the audio signals ALa and ARa from the digital audio player 101. Also, the play screen contains a mat image 58. The mat image 58 is an image simulating the mat 2 of FIG. 1, and is divided into four areas a1, a2, a3, and a4. The areas a1, a2, a3, and a4 correspond to the step areas ST1, ST2, ST3, and ST4 of the mat 2 respectively. Incidentally, the term “area a” is used to generally represent the areas a1, a2, a3, and a4.

Further, the play screen contains moving objects 50. The moving object 50 on a path L1 appears at the upper end of the screen, and then descends with a constant velocity toward the area a1. The moving object 50 on a path L2 appears at the upper end of the screen, and then descends with a constant velocity toward the area a2. The moving object 50 on a path L3 appears at the upper end of the screen, and then descends with a constant velocity toward the area a3. The moving object 50 on a path L4 appears at the upper end of the screen, and then descends with a constant velocity toward the area a4. In this case, a plurality of patterns is prepared as an appearance pattern of the moving objects 50. The term “appearance pattern” represents appearance positions (L1 to L4) and appearance sequence of the moving objects 50, and does not include appearance timing. Needless to say, the processor 20 may determine the appearance pattern in a random manner. The processor 20 may determine initial appearance timing of the moving objects 50 in a random manner, or set the initial appearance timing preliminarily. Incidentally, the term “path L” is used to generally represent the paths L1 to L4.

The player basically plays on the mat 2. When the player steps on the step area ST at timing when the corresponding moving object 50 reaches the corresponding area a of the mat image 58, and turns on the corresponding foot switch SW, the moving object 50 ascends (bounces) along the path L along which the moving object 50 has descended, and then disappears at the upper end of the screen. Incidentally, the processing for bouncing the moving object 50 may be performed not only at the rigorous timing when the moving object 50 reaches the area a but also in the case where the foot switch SW is turned on at time when the corresponding moving object 50 is present within a certain range including the corresponding area a.

The player performs stepping motion (stomping motion) on the mat 2 in synchronization with music based on the audio signals ALa and ARa from the digital audio player 101. The processor 20 detects a cycle of the stepping motion of the player on the basis of the ON/OFF information of the foot switches SW. Then, when the cycle of the stepping motion of the player is stationary (stable), the processor 20 predicts timing of the future stepping motion of the player on the basis of the cycle, and determines the generation (appearance) timing of the moving object 50 so that the predicted timing of the stepping motion coincides with timing when the moving object 50 reaches the area a of the mat image 58.

Accordingly, the moving object 50 is generated and descends in synchronization with the stepping motion if the player performs the stepping motion in constant timing in synchronization with the music, and therefore the player can naturally bounce the moving object 50 only by performing the stepping motion in time to the music with his/her feeling without being conscious of the timing when the moving object 50 reaches the area a. Also, in the case where the moving objects 50 bounce one after another, the case represents that the player performs the stepping motion in a constant cycle, and therefore the player can recognize that he/she performs the stepping motion in the constant cycle by watching the bounces of the moving objects 50.

Further, in general, it is believed that there are differences among individuals with respect to perception of a beat and a rhythm of music. Even there are the differences among individuals, it is possible to effect the appearance of the moving objects 50 in synchronization with the stepping motion of each person. By the way, although it is also possible to effect the appearance of the moving objects 50 in synchronization with a beat and a rhythm of music by analyzing a frequency of the music from the digital audio player 101, in this case, the player has to perform the stepping motion while being conscious of the timing when the moving object 50 reaches the area a, and therefore it is difficult for the player. In the present embodiment, the player can bounce the moving objects 50 in good timing only by performing the stepping motion in his/her rhythm. That is, the differences among individuals with respect to perception of a beat and a rhythm of music are absorbed by determining the generation timing of the moving objects 50 on the basis of the stepping motion of the player.

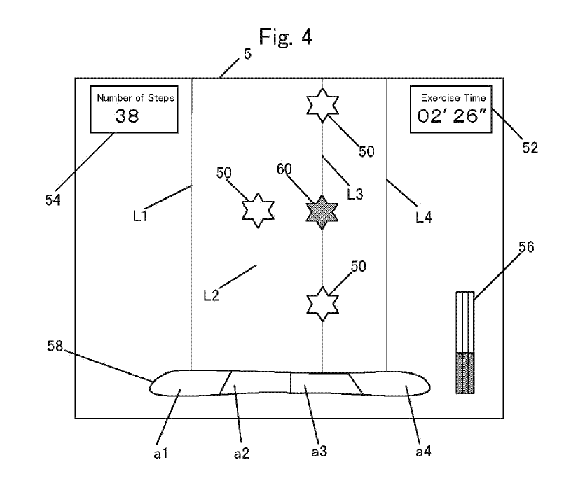

FIG. 4 is a view showing another example of a play screen. Referring to FIG. 4, a moving object 60 whose color is different from the moving object 50 appears in the play screen. The moving object 60 indicates that the appearance pattern of the subsequent moving objects 50 changes. However, in the case where the foot switch SW is turned on at timing when the corresponding moving object 60 reaches the corresponding area a, and thereby the moving object 60 bounces, the appearance pattern of the subsequent moving objects 50 changes.

In FIG. 4, the moving object 50 on the path L2 and the moving object 60 on the path L3 are aligned in a horizontal direction and descend. Then, the two moving objects 50 descend on the path L3 in such a manner the moving object 60 is sandwiched in between. Accordingly, the moving object 60 does not bounce as long as the player alternately stomps in good timing and therefore the appearance pattern does not change. Incidentally, the term “moving object obj” is used to generally represent the moving objects 50 and 60.

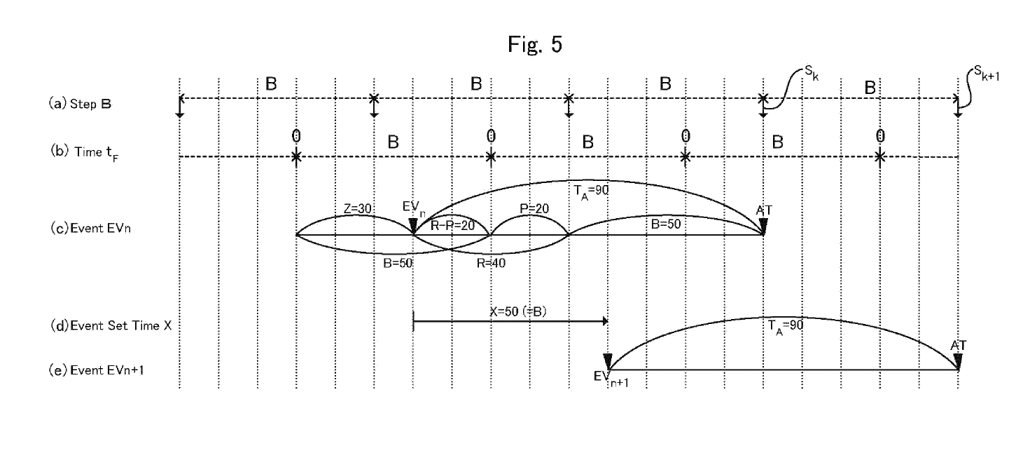

Next, the method for determining the generation timing of the moving object obj, i.e., the set timing of the event EVn will described referring to the figures. Incidentally, in the present embodiment, when the player lifts a leg and then puts down it, such motion is called a “step”. Accordingly, alternate steps correspond to the stepping motion. Also, when the processor 20 detects that the foot switch SW is turned on from its off-state, the processor determines that the player performs the step. Further, it is assumed that a descending velocity of the moving object obj is constant. Accordingly, a time T_{A} until the moving object obj reaches the area a from when the moving object obj appears at the upper end of the screen is constant. In the examples of FIGS. 5 to 7, it is assumed that the time T_{A} is 90 video frames. In this case, one video frame is 1/60 second.

FIG. 5 is an explanatory view of a method for determining the set timing of the event EVn. As shown in FIG. 5(a), the processor 20 obtains a cycle B of the step of the player on the basis of the ON/OFF information of foot switches SW. It can be considered that the cycle B of the step of the player is a cycle of a beat or rhythm which the player generates by listening to music. In the examples of FIGS. 5 to 7, it is assumed that the cycle B is 50 video frames. It is assumed that an interval between broken lines is 10 video frames in the figures. Incidentally, the processor 20 does not distinguish the right step from the left step.

As shown in FIG. 5(b), the processor 20 has a clock t_{F} which starts from time 0, counts until time (B−1), and then returns to time 0 again.

As shown in FIG. 5(c), it is assumed that the processor 20 sets the n-th event EVn (a black inverted triangle EVn) after the elapse of Z (=30) video frames from the time t_{F}=0. The setting of the event EVn corresponds to an instruction for generating the moving object obj. The processor 20 makes the moving object obj appear at the upper end of the screen at time when the event EVn is set. Then, the processor 20 makes the moving object obj descend with a constant velocity toward the area a. Then, the moving object obj reaches the area a (a black inverted triangle AT) after the elapse of the time T_{A} (=90 video frames) from the setting of the event EVn (the generation of the moving object obj). The event EVn is an event for the k-th step of the player.

As shown in FIGS. 5(d) and 5(e), the processor 20 sets the (n+1)-th event EVn+1 after the elapse of X video frames from the setting time of the event EVn. In this case, X=B=50. Because the cycle of the step of the player is the cycle B. The processor 20 makes the moving object obj appear at the upper end of the screen at time when the event EVn+1 is set. Then, the processor 20 makes the moving object descend with the constant velocity toward the area a. Then, the moving object obj reaches the area a (a black inverted triangle AT) after the elapse of the time T_{A} (=90 video frames) from the setting of the event EVn+1 (the generation of the moving object obj). The event EVn+1 is an event for the (k+1)-th step of the player.

By the way, as is obvious from the FIG. 5(c), a time Z from base time 0 of the clock t_{F} until the setting of the event EVn is represented by the following formula.

Z=B−(R−P) (1)

The term P indicates a deviation of the step of the player from the base time 0 of the clock t_{F}, i.e., a phase of the step of the player from the base time 0 of the clock t_{F}. The term R represents a remainder obtained by dividing the reaching time T_{A} by the cycle B.

The reaching time T_{A} of the moving object obj is constant, and therefore it is possible to predict timing of the future step of the player by obtaining the cycle B and the phase P of the step of the player. Accordingly, it is possible to set the event EVn so as to coincide with the future step of the player.

By the way, in the example of the FIG. 5(c), the event EVn is set in the appropriate timing. However, an error E may occur in the set timing of the event EVn. In this case, the set timing of the next event EVn+1 has to been adjusted. If it is not adjusted, the error E is accumulated, and thereby timing at which the moving object obj reaches the area a deviates from the step of the player. Therefore, the following adjustment is performed.

First, adjustment when the event EVn is set earlier will be described. Such case occurs when the phase P of the step of the player varies to become large. In what follows, the example, in which the phase P changes from 20 video frames (the case of FIGS. 5) to 30 video frames, is cited.

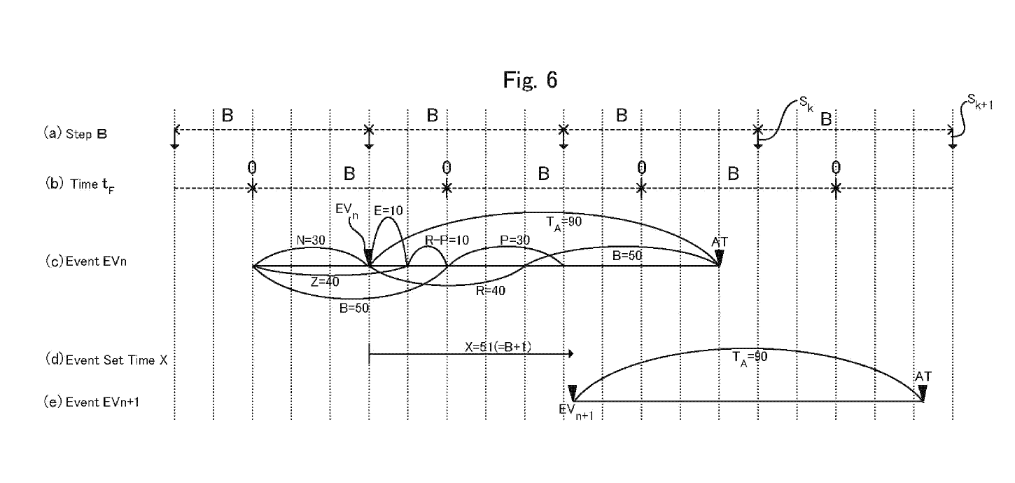

FIG. 6 is an explanatory view of a method for determining set timing of the next event EVn+1 when the event EVn is set earlier. As shown in FIG. 6(c), it is assumed that the processor 20 sets the n-th event EVn after the elapse of N (=30) video frames from the time t_{F}=0 (a black inverted triangle EVn). Although the n-the event EVn has to been set after the elapse of Z video frames (=40) from the time t_{F}=0 because the phase P changes to become large, the event EVn is set earlier by 10 video frames. That is, the error E in the setting is the positive 10 video frames.

As is obvious from the FIG. 6(c), even the case where the event EVn is set earlier, the above formula (1) and the following formula are true.

E=Z−N=B−(R−P)−N=B−R+P−N (2)

The term N represents an actual time from the base time 0 of the clock t_{F} until the setting of the event EVn. The term Z is a correct time from the base time 0 of the clock t_{F} until the setting of the event EVn.

In the case where the event EVn is set earlier, if the next event EVn+1 is set after the elapse of X (=B=50) video frames from the set time of the event EVn, naturally, the event EVn+1 is also set earlier. Accordingly, it needs to retard the set time of the event EVn+1. In this case, in the above example, since the event EVn is set earlier by the error E (=10), the next event EVn+1 may be set more retarded by the error E (=10). However, in the present embodiment, in the case where the event EVn is set earlier, absolutely, the next event EVn+1 is set more retarded by one video frame regardless of magnitude of the error E. That is, as shown in FIG. 6(d), in the case where the event EVn is set earlier, the next event EVn+1 is set after the elapse of X (=B+1=50+1) video frames from the set time of the event EVn.

In the case where the event EVn is set earlier, an event generation time X is represented by the following formula.

X=B+1 (3)

Incidentally, in the example of FIG. 5, Z=N, and therefore E=0. That is, the set time of the event EVn is correct. Accordingly, the event generation time X is represented by the following formula.

X=B (4)

Next, adjustment when the event EVn is set more retarded will be described. Such case occurs when the phase P of the step of the player changes to become small. In what follows, the example, in which the phase P changes from 20 video frames (the case of FIG. 5) to 10 video frames, is cited.

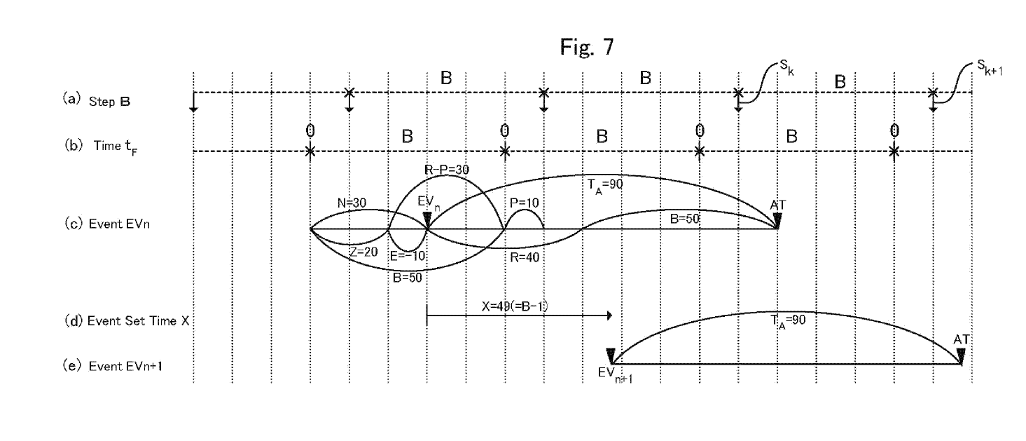

FIG. 7 is an explanatory view of a method for determining set timing of the next event EVn+1 when the event EVn is set more retarded. As shown in FIG. 7(c), it is assumed that the processor 20 sets the n-th event EVn after the elapse of N (=30) video frames from the time t_{F}=0 (a black inverted triangle EVn). Although the n-the event EVn has to been set after the elapse of Z video frames (=20) from the time t_{F}=0 because the phase P changes to become small, the event EVn is set more retarded by 10 video frames. That is, the error E in the setting is the negative 10 video frames.

As is obvious from the FIG. 7(c), even the case where the event EVn is set more retarded, the above formulae (1) and (2) are true.

In the case where the event EVn is set more retarded, if the next event EVn+1 is set after the elapse of X (=B=50) video frames from the set time of the event EVn, naturally, the event EVn+1 is also set more retarded. Accordingly, it needs to expedite the set time of the event EVn+1. In this case, in the above example, since the event EVn is set more retarded by the error E (=−10), the next event EVn+1 may be set earlier by the error E (=−10). However, in the present embodiment, in the case where the event EVn is set more retarded, absolutely, the next event EVn+1 is set earlier by one video frame regardless of magnitude of the error E. That is, as shown in FIG. 7(d), in the case where the event EVn is set more retarded, the next event EVn+1 is set after the elapse of X (=B−1=50−1) video frames from the set time of the event EVn.

In the case where the event EVn is set more retarded, an event generation time X is represented by the following formula.

X=B−1 (5)

As described above, the next event EVn+1 is set earlier or more retarded by one video frame absolutely without adjusting completely the error E for the following reason. Unlike a beat (rhythm) of music, since it is difficult that a cycle of a step of a person becomes constant, even if the error E is completely adjusted after the phase P changes somewhere, then the phase P may change again to turn back. Under such circumstances, it makes no sense to adjust. In this way, a characteristic of the step of the player, i.e., the beat (rhythm) generated by the player is considered, and therefore the error E is gradually made small.

Next, the process flow of the processor 20 will be described using flowcharts.

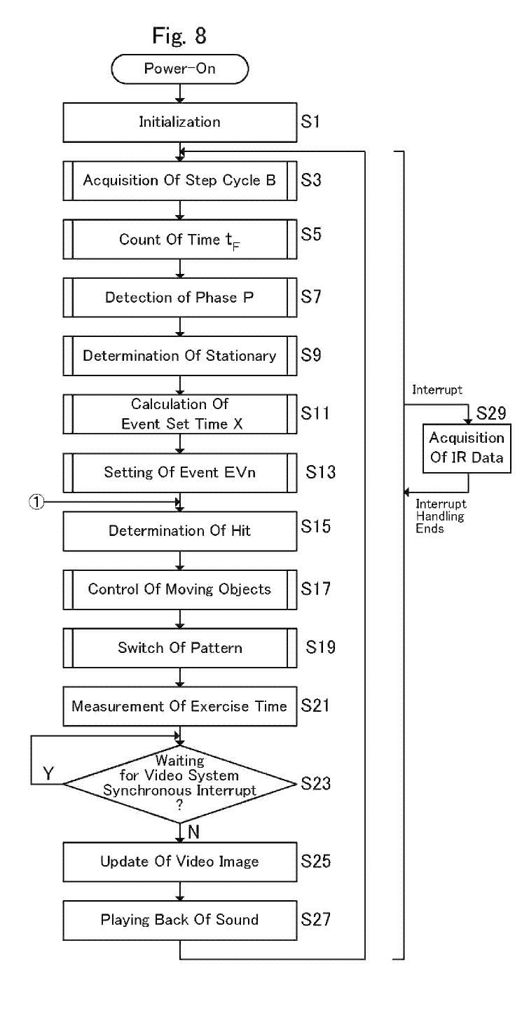

FIG. 8 is a flow chart showing an overall process flow of the processor 20 of FIG. 2. Referring to FIG. 8, in step S1, the processor 20 performs the initial settings of the system. In this step S1, variables, counters, timers, flags, and the clock t_{F} are initialized.

In step S3, the processor 20 performs the process for acquiring the cycle B of the step of the player. In step S5, the processor 20 performs the process for counting the time t_{F}, i.e., the time counting processing of the clock t_{F}. In step S7, the processor 20 performs the process for detecting the phase P of the step of the player. In step S9, the processor 20 performs the process for determining whether or not the step of the player is stationary (stable).

In step S11, the processor 20 calculates the event set time X. In step S13, the processor 20 sets the event EVn. In step S15, the processor 20 determines whether or not the foot switch SW changes from an off-state to an on-state by stepping on the corresponding step area ST at the timing when the corresponding moving object obj reaches the corresponding area a (whether or not hit).

In step S17, the processor 20 controls the appearance, the descent, the ascent (bounce), and the disappearance of the moving objects obj. The particularity is as follows.

The processor 20 performs the set for effecting the appearance of the moving object obj in accordance with appearance pattern data when the event flag is turned on. The event flag as turned on indicates that the event EVn is set. Also, the appearance pattern data is data which defines the appearance pattern of the moving objects obj. And, the processor 20 performs the set for effecting the descent of the moving object obj with the constant velocity, which has appeared. Also, the processor 20 performs the set for effecting the ascent of the moving object obj when the hit is determined in step S15. Incidentally, in step S17, the process for determining that either the moving object 50 or the moving object 60 appears is performed.

In step S19, the processor 20 performs the process for switching the appearance pattern of the moving objects obj. In step S21, the processor 20 measures the exercise time of the player so as to display on the exercise time displaying section 52.

In step S23, the processor 20 determines whether or not the interrupt based on the video system synchronous signal is waited for, the processor 20 returns to step S23 if the state is a state of waiting for the interrupt, conversely, if the state is not the state of waiting for the interrupt, i.e., if the interrupt based the video system synchronous signal is given, in step S25, the processor 20 updates the images to be displayed on the television monitor 5 on the basis of the results of the processes of steps S3 to S21 while the processor 20 performs the sound processing with regard to the sound effect and so on in step S27, and then the processor 20 proceeds to step S3.

In step S29, the processor 20 performs interrupt process, which is a process for acquiring the result of the key scan as received and output by the IR receiver 24 of the adapter 1.

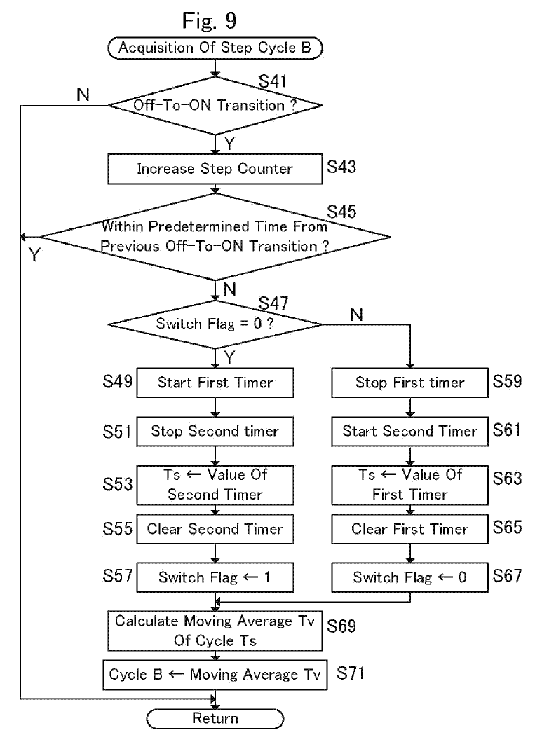

FIG. 9 is a flow chart showing the process for acquiring the cycle B of the step of the player in step S3 of FIG. 8. Referring to FIG. 9, in step S41, the processor 20 determines whether or not the off-to-on state transition of the foot switch SW occurs, the process returns if it does not occur, conversely the process proceeds to step S43 if it occurs. In step S43, the processor 20 increases a step counter by one. The step counter counts the number of steps of the player so as to display on the step number displaying section 54. In step S45, the processor 20 determines whether or not the current transition occurs within a predetermined time from the off-to-on state transition of the foot switch SW which occurred before by one, the process returns if it occurs within the predetermined time, otherwise the process proceeds to step S47. This process is a process which does not regard the current step as a step when the off-to-on state transition of the foot switch SW is continuously detected temporally closely. For this reason, for example, when the player jumps, it is determined that the action is not two steps but one step.

In step S47, the processor 20 determines whether or not a switch flag for switching between a first timer and a second timer indicates 0, the process proceeds to step S49 if it indicates 0 which represents the start of the first timer and the stop of the second timer, conversely the process proceeds to step S59 if it indicates 1 which represents the stop of the first timer and the start of the second timer. The first and second timers alternately measure a time from a step until the next step of the player.

In step S49, the processor 20 starts the first timer being stopped. In step S51, the processor 20 stops the second timer being invoked. In step S53, the processor 20 assigns the value of the second timer to a cycle Ts. In step S55, the processor 20 clears the second timer. In step S57, the processor 20 sets the switch flag to 1.

On the other hand, in step S59, the processor 20 stops the first timer being invoked. In step S61, the processor 20 starts the second timer being stopped. Instep S63, the processor 20 assigns the value of the first timer to the cycle Ts. In step S65, the processor 20 clears the first timer. In step S67, the processor 20 sets the switch flag to 0.

In step S69 after step S57 or step S67, the processor 20 calculates a moving average Tv of the cycles Ts. In step S69, the processor 20 sets the cycle B of the step of the player to the moving average Tv, and then returns.

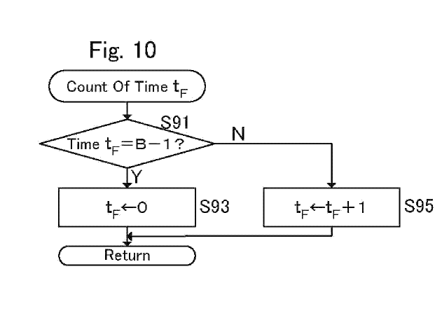

FIG. 10 is a flow chart showing a process for counting the time t_{F} in step S5 of FIG. 8. Referring to FIG. 10, in step S91, the processor 20 determines whether or not the clock t_{F} coincides with B−1, the process proceeds to step S93 so as to set the clock t_{F} to 0 if it coincides, conversely, the process proceeds to step S95 if it does not coincide. In step S93, the processor 20 sets the clock t_{F} to 0, and then returns. On the other hand, in step S95, the processor 20 increases the clock t_{F} by one, and then returns.

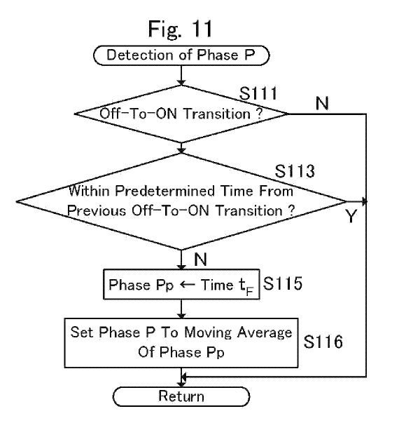

FIG. 11 is a flow chart showing a process for detecting the phase P in step S7 of FIG. 8. Referring to FIG. 11, in step S111, the processor 20 determines whether or not the off-to-on state transition of the foot switch SW occurs, the process proceeds to step S113 if it occurs, conversely the process returns if it does not occur. In step S113, the processor 20 determines whether or not the current transition occurs within a predetermined time from the off-to-on state transition of the foot switch SW which occurred before by one, the process returns if it occurs within the predetermined time, otherwise the process proceeds to step S115. The process of step S113 is executed for the same reason as the process of step S45 of FIG. 9. In step S115, the processor 20 sets a phase Pp to the current time of the clock t_{F}. Then, in step S116, the processor 20 calculates a moving average of the phases Pp, regards it as the phase P of the step, and then returns.

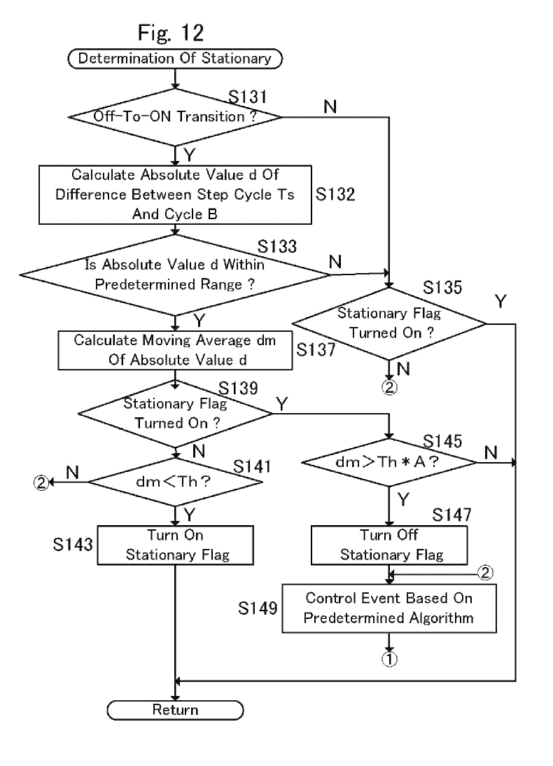

FIG. 12 is a flowchart showing a process for determining a stationary state in step S9 of FIG. 8. Referring to FIG. 12, in step S131, the processor 20 determines whether or not the off-to-on state transition of the foot switch SW occurs, the process proceeds to step S132 if it occurs, conversely the process proceeds to step S135 if it does not occur.

In step S132, the processor 20 calculates an absolute value d of a difference between the cycle Ts of the step before the moving average (see steps S53 and 63 of FIG. 9) and the cycle B of the step after the moving average (see step S71 of FIG. 9).

In step S133, the processor 20 determines whether or not the absolute value d is present within a predetermined range, the process proceeds to step S135 if it is not present within the predetermined range, conversely the process proceeds to step S137 if it is present within the predetermined range. In step S137, the processor 20 calculates a moving average dm of the absolute values d.

In step S139, it is determined whether or not a stationary flag is turned on, the process proceeds to step S145 if it is turned on, conversely the process proceeds to step S141 if it is turned off. The stationary flag indicates that the step of the player is stationary. In step S141, the processor 20 determines whether or not the moving average dm is below a threshold value Th, it is regarded that the step is stationary if it is below, and therefore the process proceeds to step S143, otherwise the process proceeds to step S149.

In step S143, the processor 20 turns on the stationary flag, and then returns. On the other hand, in step S145, the processor 20 determines whether or not the moving average dm exceeds a value obtained by multiplying the threshold value Th by A (“A” is a number exceeding 1), the process proceeds to step S147 if it exceeds, otherwise the process returns. In step S147, the processor 20 turns off the stationary flag.

In step S135, the processor 20 determines whether or not the stationary flag is turned on, the process returns if it is turned on, conversely the process proceeds to step S179 if it is turned off.

In the case where the stationary flag is turned off, in step S149, the processor 20 controls an ON/OFF state of the event in accordance with a predetermined algorithm which does not depend on the stepping motion of the player, and then proceeds to step S15 of FIG. 8. On the other hand, in the case where the stationary flag is turned on, the process proceeds to steps S11 and S13 of FIG. 8 after “YES” in step S135, “NO” in step S145, or step S143, the ON/OFF state of the event is controlled depending on the stepping motion of the player.

It is often difficult to execute a process based on motion of the player which is not stationary while it is often relatively easy to execute a process based on motion of the player which is stationary. Accordingly, before the stepping motion of the player is stationary, the event is set in accordance with the predetermined algorithm which does not depend on the stepping motion of the player, meanwhile, after the stepping motion of the player is stationary, the event is set in synchronization with the stepping motion of the player. In this way, it is possible to simplify design of the system by switching the processing in accordance with the stationary state and unstationary state of the stepping motion of the player.

As described above, in the processes shown in FIG. 12, it is determined how much the time Ts between the current step of the player and the step before by one deviates relative to the cycle B which is a moving average. That is, when the absolute value d of the difference between the time Ts and the cycle B is larger, the deviation of the actual step relative to the cycle B is large, and it indicates that the step is unstable. On the other hand, when the absolute value d of the difference is smaller, the deviation of the actual step relative to the cycle B is small, and it indicates that the step is stationary (stable).

Incidentally, since the cycle B is a moving average, (B−Ts) indicate a deviation. Needless to say, a standard deviation is obtained, when it is present within a certain range, it may be determined that the step is stationary.

Also, a hysteresis characteristic is given by defining Th<Th*A, and either the stationary state or unstationary state is determined. While the input operation (step) of a person is unstable, it is possible to avoid occurrence of needless inversion of the state (the change from the unstationary state to the stationary state, or the change from the stationary state to the unstationary state) by having the hysteresis.

Further, the process of step S133 is executed so as not to use the time Ts as an element for determining the stationary state by ignoring the time Ts when the time Ts of the actual step is greatly different from the cycle B. Herewith, it is possible to determine the stationary state in consideration that a person performs the input operation (step). Even if the input operation (step) is stationary, since it is performed by a person, it may suddenly become unstationary and shortly become stationary. In this case, by determining continuance of the stationary state, it is possible to provide with the process and effect smooth for the player Incidentally, in such case, if the unstationary state is determined and, immediately afterward, the stationary state is determined, it is difficult to provide with the process and effect smooth for the player.

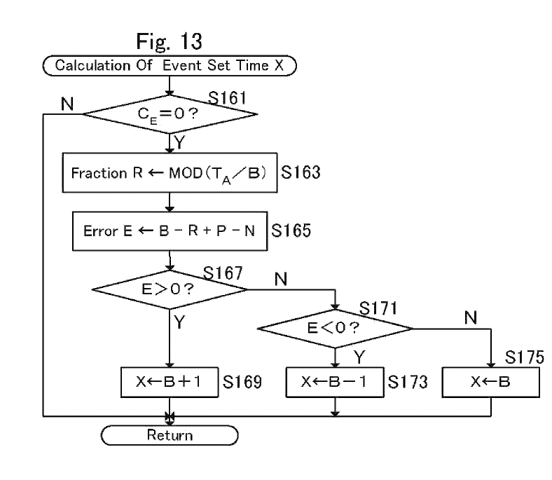

FIG. 13 is a flow chart showing a process for calculating the event set time X in step S11 of FIG. 8. Referring to FIG. 13, in step S161, the processor 20 determines whether or not a counter C_{E} which performs a countdown operation from the event set time X is 0, the process proceeds to step S163 if it is 0, conversely the process returns if it is not 0. In step S163, the processor 20 obtains the remainder (fraction) R obtained by dividing the reaching time T_{A} by the cycle B. In step S165, the processor 20 obtains the error E on the basis of the formula (2).

In step S167, the processor 20 determines whether or not the error E exceeds 0, if it exceeds 0, since the event EVn is set earlier, the process proceeds to step S169, otherwise the process proceeds to step S171. In step S169, the processor 20 assigns B+1 to the event set time X, and then returns (the formula (3)). In step S171, the processor 20 determines whether or not the error E is below 0, if it is below 0, since the event EVn is set more retarded, the process proceeds to step S173, otherwise, since the event is appropriately set, the process proceeds to step S175. In step S173, the processor 20 assigns B−1 to the event set time X, and then returns (the formula (5)). Also, in step S175, the processor 20 assigns B to the event set time X, and then returns (the formula (4)).

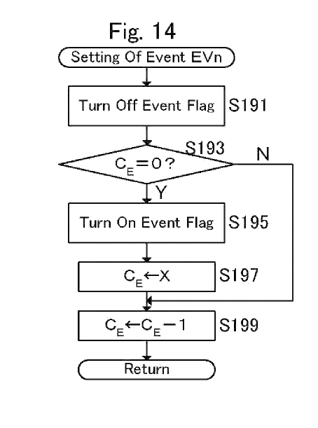

FIG. 14 is a flow chart showing a process for setting the event EVn in step S13 of FIG. 8. Referring to FIG. 14, in step S191, the processor 20 turns the event flag off. The event flag as turned off indicates that the event EVn is not set. In step S193, the processor 20 determines whether or not the counter C_{E} is 0, the process proceeds to step S199 if it is not 0, conversely the process proceeds to step S195 if it is 0. In step S195, the processor 20 turns the event flag on to set the event EVn. In step S197, the processor 20 assigns the event set time

X to the counter C_{E}. In step S199, the processor 20 decreases the counter C_{E} by one, and then returns.

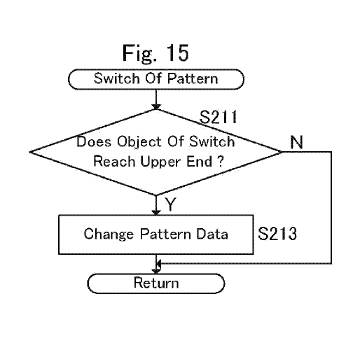

FIG. 15 is a flow chart showing a process for switching the pattern in step S19 of FIG. 8. Referring to FIG. 15, in step S211, the processor 20 determines whether or not the moving object 60 bounces and reaches the upper end of the screen, the process returns if it does not reach, conversely the process proceeds to step S213 if it reaches. The moving object 60 indicates to switch the appearance pattern. In step S213, the processor 20 changes the current appearance pattern data to the appearance pattern data different therefrom, and the returns.

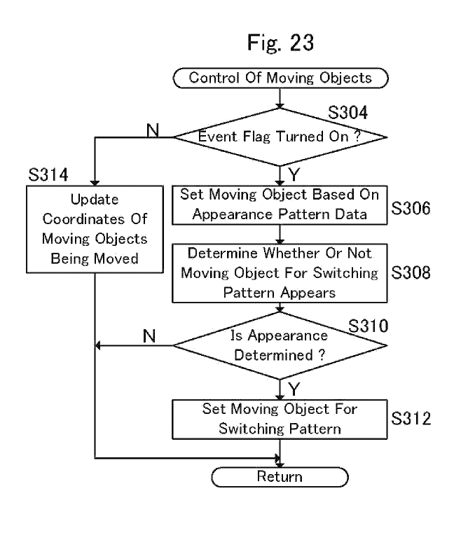

FIG. 23 is a flow chart showing a process for controlling the moving objects in step S17 of FIG. 8. Referring to FIG. 23, in step S304, the processor 20 determines whether or not the event flag is turned on, the process proceeds to step S314 if it is turned off, conversely the process proceeds to step S306 if it is turned on.

In step S306, the processor 20 sets the moving object 50 in accordance with the appearance pattern data. In step S308, the processor 20 determines by generating the random number whether or not the appearance of the moving object 60 is effected. The moving object 60 indicates to switch the appearance pattern data. However, even if the random number indicating to effect the appearance is generated, when a certain time or more does not elapse from the appearance of the previous moving object 60, the appearance is not effected. In step S310, the processor 20 proceeds to step S312 if it is determined that the moving object 60 appears, otherwise returns. In step S312, the processor 20 sets the moving object 60 so as to switch the appearance pattern data, and then returns.

In step S314 after “NO” is determined in step S304, the processor 20 updates the coordinates of the moving objects obj being moved, and then returns.

Besides, in the present embodiment, the reaching time T_{A}, and the moving distance and the moving velocity of the moving object obj are respectively constant, and the appearance timing of the moving object obj is determined on the basis of the stepping motion of the player so as to conform the timing when the moving object obj reaches the area a to the stepping motion of the player. However, the appearance position of the moving object obj may be fixed inside or outside of the screen. Also, the moving object obj may be preliminarily displayed inside of the screen and change-start timing thereof may be determined on the basis of the stepping motion of the player. Needless to say, the moving object obj may be preliminarily set outside of the screen and change-start timing thereof may be determined on the basis of the stepping motion of the player.

By the way, as described above, in accordance with the present embodiment, the occurrence timing of the future step is predicted by analyzing the step (input operation) of the player, then the event for the future step whose occurrence timing is predicted is set, and thereby it is possible to perform the real-time processing. Therefore, it is possible to be small the scale of the storage means such as a memory, and reduce the cost because a device for playing back the input signal as stored is not required, in comparison with the case where the input signal is played back and the event is set after storing temporarily and analyzing the input signal. Incidentally, in the case where the input signal is temporarily stored and analyzed, subsequently, the input signal is played back, and the event is set, a delay occurs because of the storing, analyzing, and playing back, and therefore it is not the real-time processing.

Also, in the present embodiment, the calculation of the event set time X based on the formulae (1) to (5) corresponds to the prediction of the occurrence timing of the future step of the player (see FIG. 13). Because the expression “the event set time X plus the reaching time T_{A}” represents the occurrence timing of the predicted step.

Further, since the occurrence timing of the future step of the player is predicted, while performing the real-time processing, it is possible to make the moving object obj to reach the corresponding area a at the occurrence timing of the future step of the player.

In the above case, the player performs the steps in synchronization with music while listening to the any music. In this case, in accordance with the present invention, the moving object obj is controlled on the basis of not the music but the step of the player. Accordingly, the player can bounce the moving objects obj only by performing the steps in his/her rhythm. In other words, since the image is matched to the step of the player, the player can perform the steps in a rhythm and beat which the player feels while listening to any music.

Still further, in the case where the moving objects obj bounce in a constant rhythm one after another, the case represents that the player performs the steps in the constant rhythm, and therefore the player can recognize that he/she performs the steps in the constant rhythm by watching such image.

Also, in the present embodiment, the event is set in synchronization with the step of the player after the step of the player is stationary. Accordingly, the event is set in accordance with the predetermined algorithm which does not depend on the step of the player before the step of the player is stationary, and the control according to the event can be performed.

Further, in the present embodiment, the time T_{A} until the moving object obj reaches the area a from when the moving object obj appears at the upper end of the screen is constant without depending on the step of the player. As the result, even speed of cyclic repetition of the step of the player differs, it is possible to perform the common control during the reaching time T_{A} and at the time when the time T_{A} has elapsed, and therefore the constant expression and effect can be provided without depending on the cyclic repetition of the step of the player. Incidentally, if the rhythm or beat of the music input from the digital audio player 101 differs, the player is supposed to change the speed of the cyclic repetition of the step in accordance therewith.

Still further, in accordance with the present embodiment, the prediction result (corresponding to the event set time X) of the occurrence timing of the future step is corrected in accordance with the change of the phase P of the step of the player (see FIGS. 6 and 7). That is, although it is only necessary to calculate the event set time X by the formula (4) if the phase P does not change and the error E is 0, the event set time X is corrected based on the formula (3) or (5) if the error E is not 0.

In this way, since the prediction result of the occurrence timing of the future step is corrected in accordance with the change of the phase P, even if the phase P changes in midstream of a sequence of steps, the prediction result is corrected in accordance with the change, and thereby it is possible to prevent the shift of the phase P from affecting the prediction result.

### Second Embodiment

A system configuration in accordance with the second embodiment of the present invention is the same as the system configuration of FIG. 1. However, the digital audio player 101 is not connected. Also, electric configurations of a mat unit 7, an adapter 1, and a cartridge 3 in accordance with the second embodiment are the same as the configurations of FIG. 2. However, the mixing circuits 109L and 109R are not implemented, and the audio signals Alp and ARp from the processor 20 are directly supplied to the AV cable 9. This entertainment system has a function of an action instructing apparatus.

In the second embodiment, the processor 20 displays a player character on the television monitor 5, and effects the change of the player character in accordance with ON/OF states of the foot switches SW1 to SW4. That is, the player can operate the player character on the screen (i.e., in a virtual space) by operating the foot switches SW1 to SW4.

Then, the processor 20 advances the player character in the virtual space in accordance with the ON/OFF states of the foot switches SW1 to SW4. In this case, since the processor 20 displays various kind of obstacles, the player is required that he/she advances the player character while avoiding the obstacles by operating the foot switches SW1 to SW4.

In what follows, movement of the player character and the respective obstacles will be described referring to the figures.

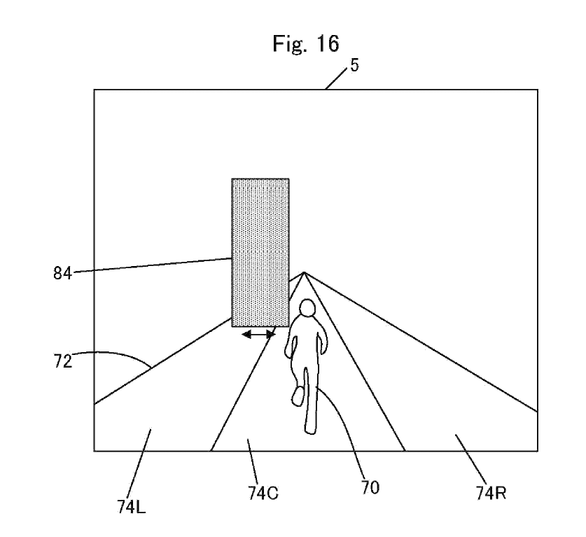

FIG. 16 is a view showing an example of a play screen. Referring to FIG. 16, the play screen is displayed on the television monitor by the processor 20, and contains a road 72, a player character 70, and a obstacle 84. The road 72 consists of three lanes 74L, 74C and 74R which are horizontally arranged.

When the player performs the stepping on the mat 2, the corresponding foot switch SW is turned on or off, and thereby the processor 20 detects the stepping of the player, and controls velocities of animations of a background containing the road 72 and the player character 70 on the basis of the speed of the stepping. Herewith, a situation, in which the player character 70 travels (walks or runs) forward at the velocity corresponding to the speed of the stepping of the player, is expressed. In other words, the player can control the forward velocity of the player character 70 by controlling the speed of the stepping. In this case, the term “forward” represents “forward” in the virtual space generated by the processor 20.

Also, when the player shifts a stepping position on the mat 2 (side step), the foot switch SW which is turned on changes, and thereby the processor 20 detects the shift of the stepping position by the player, and moves the player character 70 in the right or left direction on the basis of the stepping position after the shift. Herewith, the player moves the player character 70 in the right or left direction by controlling the stepping position. In this case, the term “right” and “left” represents “right” and “left” in the virtual space generated by the processor 20.

Since the processor 20 displays various obstacles such as the obstacle 84 on the road 72, the player advances the player character 70 while making the player character 70 avoid the obstacles such as the obstacle 84 by shifting the stepping position on the mat 2, i.e., shifting the foot switch SW to be stepped on. In this case, the processor 20 reciprocates the obstacle 84 in the direction which crosses the road 72 (from side to side).

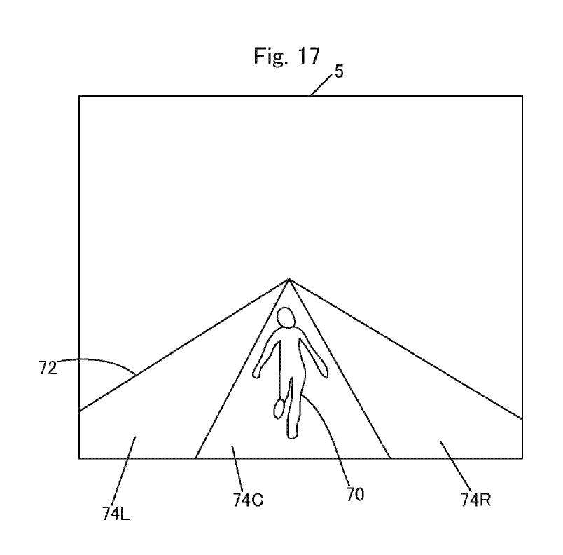

FIG. 17 is a view showing an example of a play screen containing the player character 70 which stands on one leg. Referring to FIG. 17, when the processor 20 detects a state in which two adjacent foot switches SW among four foot switches SW are simultaneously turned on (i.e., a state in which two foot switches SW are stepped on with both the feet), and subsequently detects a state in which one foot witch SW is turned off (i.e., a state in which one leg is lifted and the foot separates from the one foot switch SW), the processor 20 displays the player character 70 which stands on one leg. In this case, the processor 20 displays the image in which the player character 70 stands on the right leg when the right foot switch SW in the viewpoint of the player of the two adjacent foot switches SW which are simultaneously turned on is turned on while the processor 20 displays the image in which the player character 70 stands on the left leg when the left foot switch SW is turned on. Herewith, the player can further have a feeling of oneness with the player character 70.

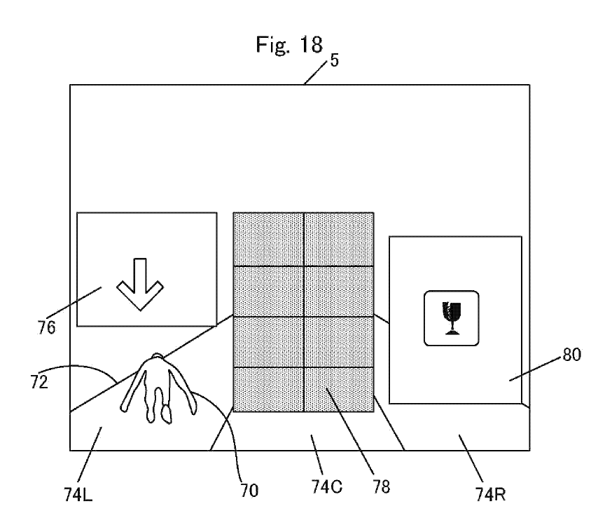

FIG. 18 is a view showing an example of a play screen containing the player character 70 which runs while keeping a crouching state. Referring to FIG. 18, the play screen contains three kinds of obstacles 76, 78 and 80, the player character 70, and the road 72. The processor 20 displays the obstacle 76 on the lane 74L, the obstacle 78 on the lane 74C, and the obstacle 80 on the lane 74R.

The player character 70 can not avoid the obstacle 76 while keeping standing, impinges on it, and therefore can not advance further. Accordingly, the player has to make the player character 70 crouch. When three or four of the four foot switches SW are simultaneously turned on (i.e., when two foot switches SW are stepped on with both the feet, one of the other foot switches SW is pressed with one hand, or the other two foot switches SW are pressed with both the hands), the processor 20 displays the image in which the player character 70 crouches.

Then, when the one foot switch SW at one end (when three or four are simultaneously turned on) or the two foot switches SW at both ends (when four are simultaneously turned on) of the foot switches SW which are simultaneously turned on keep (s) being turned on (i.e., one foot switch SW pressed with one hand is turned on, or two foot switches SW pressed with both the hands are turned on), and furthermore the other two foot switches SW repeat alternately an ON state and an OFF state (i.e., the stepping is performed on the other two foot switches SW), the processor 20 displays the image in which the player character 70 advances (walks or runs) while keeping a crouching state. Accordingly, the player can avoid, i.e., slip through the obstacle 76 by performing such operation of the foot switches SW. In this case, the term “crouch” of the player character 70 means a “crouch” in the virtual space generated by the processor 20.

Incidentally, when the player character 70 impinges on the obstacle 80 at a predetermined speed or more, the processor 20 displays the image in which the obstacle 80 is broken and the player character 70 passes through it. On the other hand, even if the player character 70 impinges on the obstacle 78 at any speed, the player character 70 can not pass through the obstacle 78.

As described above, the example of FIG. 18 allows the player to perform the stepping motion keeping the crouching state while the mat 2 which is an input device placed on a floor is employed.

In the above case, the player character 70 avoids the obstacle 76 by advancing while keeping the crouching state. The other way for avoiding will be described.

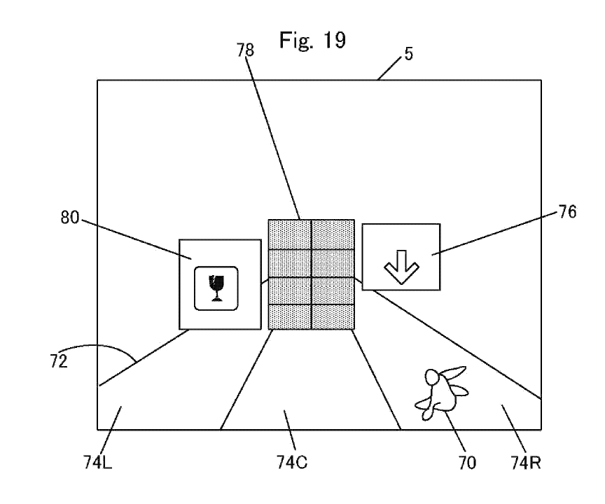

FIG. 19 is a view showing an example of a play screen containing the player character 70 which makes sliding. Referring to FIG. 19, the play screen contains the three kinds of obstacles 76, 78 and 80, the player character 70, and the road 72. The processor 20 displays the obstacle 76 on the lane 74R, the obstacle 78 on the lane 74C, and the obstacle 80 on the lane 74L.

When the player performs the stepping at a predetermined speed or more so as to turn on the two foot switches SW alternately, and thereby the player character 70 runs at a certain speed or more, if the player presses the other one or two foot switch (es) with a hand (s) to turn on, the processor 20 displays the image in which the player character 70 makes sliding forward. Accordingly, the player can avoid, i.e., slip through the obstacle 76 also by performing such operation of the foot switches SW.

As described above, the example of FIG. 19 allows the player to perform the crouching motion stepping while the mat 2 which is an input device placed on a floor is employed.

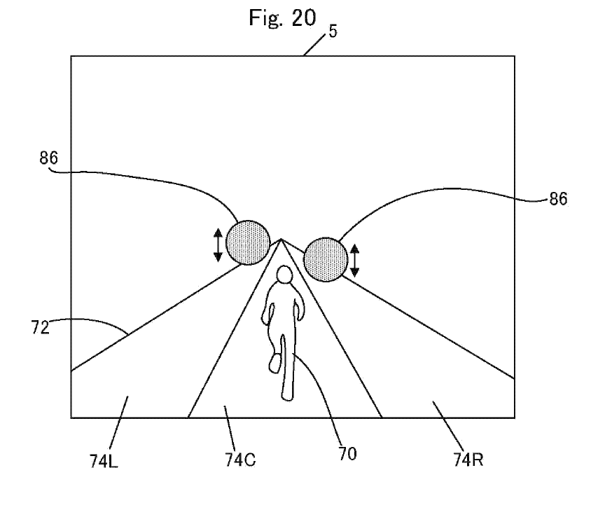

FIG. 20 is a view showing an example of a play screen containing an obstacle 66 which moves in a vertical direction. Referring to FIG. 20, the processor 20 displays the obstacle 86 which reciprocates in the vertical direction (up and down) on the road 72. The player operates the player character 70 by operating the foot switches SW, and has to avoid the obstacle 86 to advance.

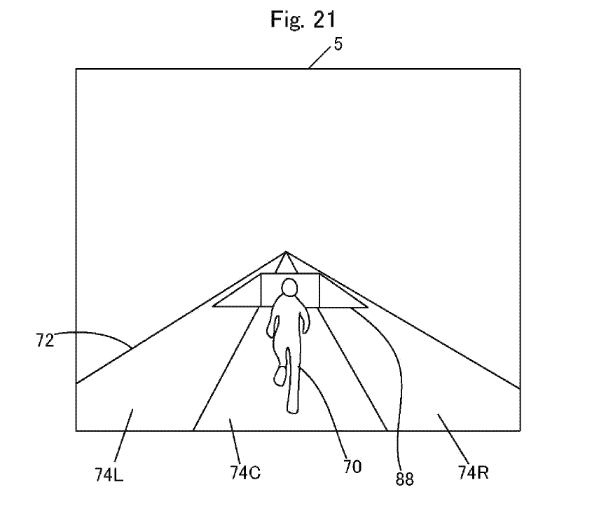

FIG. 21 is a view showing an example of a play screen containing a pit 68. Referring to FIG. 21, the processor 20 displays the pit 68 on the road 72. Accordingly, the player operates the player character 70 by operating the foot switches SW, and has to overjump the pit 68 to advance. That is, when the player jumps on the mat 2, the two foot switches SW which simultaneously have been turned on are turned off, thereby the processor 20 detects the jump motion by the player, and makes the player character 70 jump to overjump the pit 68. In this case, the processor 20 calculates a flying distance of the player character 70 on the basis of the stepping speed before detecting the jump motion of the player. In this case, the term “jump” of the player character 70 means a “jump” in the virtual space generated by the processor 20.

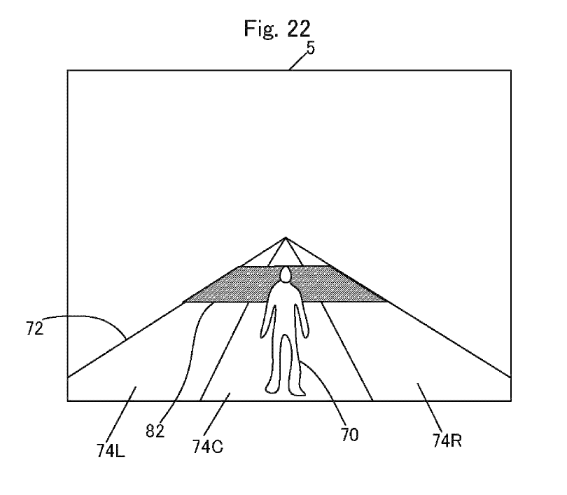

FIG. 22 is a view showing an example of a play screen containing a road surface 82 which moves in a direction opposite to an advancing direction of the player character 70. Referring to FIG. 22, the processor 20 displays the road surface 82 which moves in the direction opposite to the advancing direction of the player character 70 on the road 72. In this case, the movement of the road surface 82 represents not movement of the road surface itself but rotational movement like a belt conveyor. Naturally, although the road surface 82 itself also moves with the advance of the player character 70 while working the rotational movement, this is a process for expressing the advance of the player character 70.

The player character 70 is brought back in the direction opposite to the advancing direction on the road surface 82, and therefore the player has to advance the player character 70 at the faster speed. That is, the player has to repeat the ON state and OFF state of the foot switches SW more quickly by stepping more quickly.

As described above, as shown in FIGS. 16 to 22, the player advances the player character 70 while adjusting the forward speed of the player character 70 by controlling the stepping speed, and avoids the respective obstacles such as the obstacles 76, 78, 80, 84, 86, 88, and 82 while performing the shift of the stepping position (side step), the jump, the crouching motion, the stepping motion while keeping the crouching state, or the crouching motion while stepping.

Meanwhile, the present invention is not limited to the above embodiment, and a variety of variations may be effected without departing from the spirit and scope thereof, as described in the following modification examples.

(1) In the first embodiment, the external audio signal is input from the digital audio player 101. However, it may be input from the other recording medium such as a CD player and a DVD player. Also, audio is converted into the electrical signal by a microphone, and it may be the input audio signal from outside. Further, the external audio signal may be supplied through a communication line such as LAN and Internet.

(2) As is obvious from the descriptions of the first embodiment, the entertainment system of FIG. 1 can be called a timing controlling system. Also, the cartridge 3 can be called a timing controller. Because, the event is set so as to coincide with the future step of the player, and thereby the predetermined result is effected In this case, the predetermined result means that an object to be controlled becomes a predetermined state. The term “predetermined state” contains a predetermined appearance, a predetermined position, predetermined sound, and so on. In the above example, the predetermined result is that the moving object obj reaches the area a at the occurrence timing of the future step as predicted.

(3) In the above case, the appearance timing of the predetermined image, i.e., the moving object obj is controlled in response to the event as set, and the predetermined result, i.e., the reaching of the moving object obj to the area a is effected at the predicted occurrence timing of the step. However, the predetermined image to be controlled is not limited to the moving object obj, and any image may be controlled.

Also, the predetermined image to be controlled is preliminarily displayed on the screen, and the change-start timing of the predetermined image may be determined on the basis of the step of the player. That is, the change of the predetermined image is started in response to the above event. In this case, a time from the start of the change of the predetermined image until the end thereof is the constant time T_{A} , and a change speed is also constant. Further, in this case, the predetermined image may be used repeatedly by returning to the original change-start state again after ending the change. Still further, in this case, a plurality of the predetermined images may be displayed, and alternately changed in response to the events.

(4) In the first embodiment, the ON/OFF information of the foot switches SW is input, the stepping motion of the player is analyzed, and the occurrence timing of the future stepping motion is predicted. However, a signal to be input and analyzed is not limited to the ON/OFF information of the foot switch SW. For example, the signal may be a manipulated signal of not the foot switch but a hand-input-type switch. In this case, the predetermined image (e.g., moving object) can be controlled in synchronization with the manipulated signal. The switch is, for example, a switch of a hand-input-type controller such as a controller for a game machine, a switch of a keyboard, and so on.

Also, for example, the signal to be input and analyzed may be a trigger signal which is generated when a predetermined condition is satisfied. In this case, the predetermined image (e.g., moving object) can be controlled in synchronization with the trigger signal. Incidentally, as described above, an image which responds to the trigger signal may be displayed (e.g., mat image 58) in addition to the predetermined image to be controlled (e.g., moving object).

The trigger signal is, for example, a signal which is generated when movement of an input device which is moved in a three-dimensional space by the player satisfies predetermined condition. The predetermined condition is, for example, that an acceleration of an input device exceeds a predetermined value. In this case, an acceleration sensor is implemented in the input device.

Also, for example, an imaging device such as CCD and an image sensor images motion of the player, the motion of the player is detected by analyzing the image, and the trigger signal is generated when the motion satisfies predetermined condition. In this case, a retroreflective member is grasped by or attached to the player, a light-emitting device (e.g., infrared light emitting diode) intermittently irradiates it with light (e.g., infrared light), and the movement of the retroreflective member, i.e., the player is detected based on a differential image between an image at the light emitting period and an image at the non-light emitting period (differential processing). Since the retroreflective member irradiated with the light is photographed, luminance of an image of the retroreflective member in the photographed image is higher than that of the background, and therefore it is easily possible to extract the image thereof. Also, it is simply possible to eliminate light other than the light reflected by the retroreflective member by the differential process.

However, a apparatus having a light-emitting device such as an infrared light emitting diode may be attached to or grasped by the player in place of the retroreflective member. In this case, since the difference processing is not required, the light-emitting device for performing the differential processing is unnecessary. A cursor which interlocks with the motion of the player may be displayed.

Incidentally, although the above stroboscope imaging (the blinking of the light-emitting device) and the differential processing are cited as the preferable example, these are not essential elements. That is, the light-emitting device does not have to blink, or there may be no need of the light-emitting device. Light to be emitted is not limited to the infrared light. Also, the retroreflective member is not essential element if it is possible to detect an input device grasped by the player or a certain part (e.g., hand or foot) of a body by analyzing the photographed image.

Further, for example, an electronic device in which an imaging device is implemented is held by the player, it may be used as an input device. In this case, a plurality of markers is attached along an edge of a screen of a television monitor. The makers are photographed by the imaging device of the input device, the processor determines which position on the screen the player indicates, and displays the cursor thereon. The trigger signal is generated when the movement of the cursor satisfies predetermined condition. The marker is, for example, a light-emitting device such as an infrared light diode. Also, the marker may be a retroreflective member. In this case, a light-emitting device is installed in the input device. Further, the differential image may be processed by blinking the light-emitting device.

Still further, for example, the trigger signal may be generated in accordance with the strike by detecting the strike by the player. For example, the strike is detected by a switch, a piezoelectric device, and so on.

(5) In the above case, the position of the predetermined image (the moving object obj), which is an object to be controlled, changes (descents) in response to the event. However, it is not limited to a movement which is a change of a position, an appearance of the predetermined image, which is an object to be controlled, may change in response to the event. The term “appearance” is used as a term including shape, pattern, and color.

### First Modification Example

For example, a predetermined image having a predetermined shape appears at a prescribed position or any position on a screen, in addition to it, a graphic similar to the predetermined image is displayed as a timing indicating object at the same center position. At the same time, the predetermined image changes toward the timing indicating object. In this case, the predetermined image enlarges if the timing indicating object is larger than the predetermined image, conversely the predetermined image shrinks if it is smaller. In this case, the event is set so that the timing when the predetermined image reaches the timing indicating object coincides with the step of the player.

### Second Modification Example

For example, a predetermined image having a first predetermined pattern appears at a prescribed position or any position on a screen, in addition to it, a timing indicating object having a second predetermined pattern is displayed close to the predetermined image. At the same time, a pattern of the predetermined image changes from the first predetermined pattern toward the second predetermined pattern. In this case, the event is set so that the timing when the pattern of the predetermined image becomes the pattern of the timing indicating object, i.e., the second predetermined pattern coincides with the step of the player.

### Third Modification Example

A color of the predetermined image may change. In this case, the same example as the case where the pattern of the predetermined image changes is applied. That is, in the above example with regard to the pattern, the term “pattern” is replaced by the term “color”.

(5) In the above case, an object to be controlled is a predetermined image (the moving object obj). However, the object to be controlled is not limited to an image. For example, sound, an external device, an external computer program, thing, material (solid, liquid, and gas) or the like may be optionally employed as the object to be controlled.

(Sound as an Object to be Controlled)

The cartridge 3, which is a timing controller, predicts the occurrence timing of the step of the player, and sets the event based on the prediction result. For example, at least one of timing for starting to output predetermined sound and timing for starting to change predetermined sound is determined based on the predicted occurrence timing of the step of the player, and the event is set based on the determination result. Then, the cartridge 3 controls the predetermined sound in response to the event, and allows the predetermined sound to effect the predetermined result at the predicted occurrence timing of the step of the player. In this way, since the occurrence timing of the step of the player is predicted, while performing the real-time processing, it is possible to make the predetermined sound to effect the predetermined result at the timing of the future step of the player. For example, the control of the predetermined sound is control of an element (s) such as amplitude (volume), waveform (tone color), and/or a cycle (pitch). Accordingly, the predetermined result is that the element of the sound becomes a predetermined state.

(Specific Thing or Specific Material as an Object to be Controlled)

The cartridge 3, which is a timing controller, predicts the occurrence timing of the step of the player, and sets the event based on the prediction result. For example, at least one of timing for starting a change and appearance timing of predetermined thing or material is determined based on the predicted occurrence timing of the step of the player, and the event is set based on the determination result. Then, the cartridge 3 controls the change of the predetermined thing or material in response to the event, and effects the predetermined result at the predicted occurrence timing of the step of the player. The change of the predetermined thing or material contains change of a position and/or appearance. In this way, since the occurrence timing of the step of the player is predicted, while performing the real-time processing, it is possible to make the predetermined thing or material to effect the predetermined result at the timing of the future step of the player. Incidentally, in the case where the predetermined material is gas, for example, the gas can be controlled by enclosing in a container and so on.

For example, in the case where the object to be controlled is a waterdrop, it falls from a first predetermined position to a second predetermined position. In this case, the event is set so that the time when the waterdrop reaches the second predetermined position coincides with the step of the player. In this case, the waterdrop falls from the first predetermined position in response to the setting of the event. In this example, for example, the term “waterdrop” may be replaced by the term “ball”, or “container in which gas is enclosed”. Also, for example, in the case where the object to be controlled is a jet of water, the event is set so that the time when the jetted water ascends, then descends, and further then reaches the surface of the water coincides with the step of the player. In this case, the water is jetted in response to the setting of the event.

The waterdrop, the water, and so on is not directly controlled, and the mechanism such as opening and closing of a valve such as a solenoid valve is directly controlled. Such fact is true also with regard to the other predetermined thing and material, they are directly not controlled, and a mechanism, a machine, a device and/or a computer program, and so on for controlling them is controlled and driven in response to the event.

(External Device and/or External Computer Program as an Object to be Controlled)

The cartridge 3, which is a timing controller, predicts the occurrence timing of the step of the player, and sets the event based on the prediction result. This point is the same as the above case. Then, the cartridge 3 controls an external device and/or an external computer program in response to the event, and effects the predetermined result at the occurrence timing of the step of the player. In this way, since the occurrence timing of the step of the player is predicted, while performing the real-time processing, it is possible to make the external device and/or the external computer program effect the predetermined result at the timing of the future step of the player.

(7) In the above case, when the detected timing of the step of the player substantially coincides with the timing when the moving object obj reaches the area a, the effect, which bounces the moving object obj, is generated. However, the kind of the effect is not limited to this, and may be set optionally.

(8) In the first embodiment, it may be determined whether or not the stepping motion is stationary on the basis of a difference between the detected timing of the step of the player and the predicted timing of the step.

While the present invention has been described in detail in terms of embodiments, it is apparent that those skilled in the art will recognize that the invention is not limited to the embodiments as explained in this application. The present invention can be practiced with modification and alteration within the spirit and scope of the present invention as defined by the appended any one of claims.

1. A timing controller, comprising:
an input unit operable to detect input operation by a player;
a predicting unit operable to analyze cyclic repetition of the serial input operation by the player detected by the input unit, and predict occurrence timing of a future input operation;
a setting unit operable to set an event for the future input operation on the basis of the predicted occurrence timing; and
a controlling unit operable to perform a predetermined control in response to the set event to effect a predetermined result at the predicted occurrence timing of the future input operation.

2. The timing controller as claimed in claim 1, wherein the predetermined control is control of a predetermined image, and
wherein the controlling unit controls the predetermined image in response to the set event to allow the predetermined image to effect the predetermined result at the occurrence timing as predicted.

3. The timing controller as claimed in claim 2, wherein the controlling unit controls change of the predetermined image in response to the set event to effect the predetermined result at the occurrence timing as predicted, and
wherein the change of the predetermined image includes change of a position and/or an appearance.

4. The timing controller as claimed in claim 2, wherein the setting unit determines a change-start timing or appearance timing on a screen of the predetermined image on the basis of the occurrence timing as predicted, and sets the event on the basis of a result of the determination.

5. The timing controller as claimed in claim 1, wherein the predetermined control is control of predetermined sound, and
wherein the controlling unit controls the predetermined sound in response to the set event to allow the predetermined sound to effect the predetermined result at the occurrence timing as predicted.

6. The timing controller as claimed in claim 5, wherein the setting unit determines an output-start timing or change-start timing of the predetermined sound on the basis of the occurrence timing as predicted, and sets the event on the basis of a result of the determination.

7. The timing controller as claimed in claim 1, wherein the predetermined control is control of an external device and/or an external computer program, and
wherein the controlling unit controls the external device and/or the external computer program in response to the set event to effect the predetermined result at the occurrence timing as predicted.

8. The timing controller as claimed in claim 1, wherein the predetermined control is control of a predetermined thing or a predetermined material, and
wherein the controlling unit controls the predetermined thing or the predetermined material in response to the set event to effect the predetermined result at the occurrence timing as predicted.

9. The timing controller as claimed in claim 8, wherein the controlling unit controls change of the predetermined thing or the predetermined material in response to the set event to effect the predetermined result at the occurrence timing as predicted, and
wherein the change of the predetermined thing or the predetermined material includes change of a position and/or an appearance.

10. The timing controller as claimed in claim 8, wherein the setting unit determines a change-start timing or appearance timing of the predetermined thing or the predetermined material on the basis of the occurrence timing as predicted, and sets the event on the basis of a result of the determination.

11. The timing controller as claimed in claim 1, wherein the setting unit sets the event a predetermined time prior to the occurrence timing as predicted, and
wherein the controlling unit starts the predetermined control in response to the set event to effect the predetermined result after elapse of the predetermined time.

12. The timing controller as claimed in claim 11, wherein the predetermined control is control of a predetermined image,
wherein the controlling unit starts change of the predetermined image in response to the set event to allow the predetermined image to effect the predetermined result after elapse of the predetermined time, and
wherein a process of the change of the predetermined image does not depend on the input operation.

13. The timing controller as claimed in claim 12, wherein the controlling unit sets speed of the change of the predetermined image to a constant value without depending on the input operation.

14. The timing controller as claimed in claim 1, wherein the predicting unit predicts the occurrence timing of the future input operation on the basis of a frequency and a phase of the cyclic repetition of the input operation.

15. The timing controller as claimed in claim 14, wherein the predicting unit comprising:
a cycle detecting unit operable to detect a cycle of the cyclic repetition of the input operation;
a phase detecting unit operable to the phase of the cyclic repetition of the input operation; and
a unit operable to predict the occurrence timing of the future input operation on the basis of the cycle and the phase of the cyclic repetition of the input operation.

16. The timing controller as claimed in claim 14, wherein the predicting unit corrects a result of the prediction of the occurrence timing of the future input operation in accordance with a shift of the phase of the input operation.

17. The timing controller as claimed in claim 1, wherein the controlling unit generates a predetermined effect when timing of the input operation by the player detected by the input unit substantially coincides with timing when the predetermined result is effected by the predetermined control.

18. The timing controller as claimed in claim 1, wherein the controlling unit performs the predetermined control in accordance with the event set by the event setting unit when the input operation of the player is stationary.

19. The timing controller as claimed in claim 1, wherein the input unit comprising:
a detecting unit that is placed on a floor, and detects a stepping motion as the input operation of the player.

20. The timing controller as claimed in claim 1, wherein the input unit comprising:
a detecting unit operable to detect a strike as the input operation of the player.

21. The timing controller as claimed in claim 1 further comprising:
a triggering unit operable to generate a trigger when the input operation by the player detected by the input unit satisfies a predetermined condition,
wherein the predicting unit predicts the occurrence timing of the future input operation by analyzing cyclic repetition of the trigger.

22. The timing controller as claimed in claim 21, wherein the triggering unit generates the trigger when movement of the input unit which is moved by the player in a three-dimensional space satisfies the predetermined condition.

23. The timing controller as claimed in claim 22, wherein the predetermined condition is that acceleration of the input unit exceeds a predetermined value.

24. The timing controller as claimed in claim 21, wherein the input unit detects motion of the player as the input operation on the basis of an image obtained by imaging,
wherein the triggering unit generates the trigger when the motion of the player as detected satisfies the predetermined condition.

25. The timing controller as claimed in claim 24, wherein the input unit detects the motion of the player in a three-dimensional space on the basis of the image obtained by imaging the motion of the player.

26. The timing controller as claimed in claim 25, wherein the input unit detects the motion of the player in the three-dimensional space on the basis of the image obtained by imaging when a retroreflective member which is moved by the player is irradiated with predetermined light from a side of imaging.

27. The timing controller as claimed in claim 26, wherein the input unit detects the motion of the player in the three-dimensional space on the basis of a difference image between an image obtained by imaging when irradiating the predetermined light and an image obtained by imaging when the predetermined light is not emitted.

28. The timing controller as claimed in claim 24, wherein the input unit detects the motion of the player in a three-dimensional space on the basis of an image as obtained when a plurality of markers arranged along an edge of a screen of a display device is imaged by a imaging device which is moved by the player.

29-38. (canceled)

39. a timing controlling method, comprising the steps of:
detecting input operation by a player;
analyzing cyclic repetition of the serial input operation by the player as detected to predict occurrence timing of a future input operation;
setting an event for the future input operation on the basis of the predicted occurrence timing; and
performing a predetermined control in response to the set event to effect a predetermined result at the predicted occurrence timing of the future input operation.

40. A computer readable recording medium storing a computer program, the computer program causing a computer to:
detect input operation by a player;
analyze cyclic repetition of the serial input operation by the player as detected to predict occurrence timing of a future input operation;
set an event for the future input operation on the basis of the predicted occurrence timing; and
perform a predetermined control in response to the set event to effect a predetermined result at the predicted occurrence timing of the future input operation.
